(19) United States
(12) Patent Application Publication
(10) Pub. No.: US 2026/0255080 A1
(43) Pub. Date: Aug. 27, 2026

(54) SENSOR DEVICE AND METHOD FOR OPERATING A SENSOR DEVICE

(71) Applicant: Sony Semiconductor Solutions Corporation, Kanagawa (JP)

(72) Inventors: Andreas AUMILLER, Stuttgart (DE); Dimche KOSTADINOV, Stuttgart (DE); Ryoji IKEGAYA, Stuttgart (DE)

(73) Assignee: Sony Semiconductor Solutions Corporation, Kanagawa (JP)

(21) Appl. No.: 19/163,414

(22) PCT Filed: Mar. 13, 2024
(86) PCT No.: PCT/EP2024/056638

§ 371 Date: Sep. 9, 2025

(30) Foreign Application Priority Data
Mar. 27, 2023 (EP) 23164378.4

(51) Int. Cl. H04N 25/707; H04N 19/117; H04N 19/124; H04N 19/615; H04N 23/95; H04N 25/47; H04N 25/75; H04N 25/78

(52) U.S. Cl. CPC H04N 25/707; H04N 19/117; H04N 19/124; H04N 19/615; H04N 23/95; H04N 25/47; H04N 25/75; H04N 25/78

(57) ABSTRACT

A sensor device includes a vision sensor with a pixel array having multiple event detection pixels. Each pixel receives incident light, performs photoelectric conversion, and generates event data indicating an intensity change of the light relative to a detection threshold. The device further includes an encoding unit configured to compress the event data from the pixel array using one of a plurality of compression schemes, and a control unit configured to select a compression scheme for the encoding unit. A processing unit receives the compressed event data from the encoding unit and executes predetermined processing, and the control unit selects the compression scheme based on feedback information provided by the processing unit regarding results of the predetermined processing.

### FIELD OF THE INVENTION

The present technology relates to a sensor device and a method for operating a sensor device, in particular, to a sensor device and a method for operating a sensor device that allows an improved transfer of sensor data from a vision sensor to a processing unit.

### BACKGROUND

Presently, sensor data obtained in imaging systems like active pixel sensors, APS, and dynamic/event vision sensors, DVS/EVS, are further processed to give estimates on the observed scenes. This is often done by processing units, like application processors, that are separately provided from the vision sensors. Such processing units are not necessarily designed for the treatment of data generated by DVS/EVS. Moreover, also the transfer of such data between the vision sensor and the processing unit is not optimized.

Improved sensor devices and methods for operating these sensor devices are desirable that mitigate these problems.

### SUMMARY OF INVENTION

To this end, a sensor device is provided that comprises a vision sensor that comprises a pixel array having a plurality of event detection pixels each being configured to receive light and to perform photoelectric conversion to generate event data based on the received light, which event data indicate as an event the occurrence of an intensity change of the light above an event detection threshold. The sensor device comprises further an encoding unit that is configured to compress the event data provided from the pixel array according to different compression schemes, a control unit that is configured to determine the compression scheme to be used by the encoding unit and a processing unit that is configured to receive the compressed event data from the encoding unit and to carry out predetermined processing on the compressed event data. Here, the processing unit provides feedback information about the results of the predetermined processing to the control unit, and the control unit is configured to use the feedback information to determine the compression scheme to be used.

Further, a method for operating a sensor device is provided, the method comprising: generating event data with a pixel array of a vision sensor, the pixel array having a plurality of event detection pixels each being configured to receive light and to perform photoelectric conversion to generate the event data based on the received light, which event data indicate as an event the occurrence of an intensity change of the light above an event detection threshold; determining, with a control unit of the sensor device, a compression scheme out of a plurality of different compression schemes, which compression scheme is to be used by an encoding unit of the sensor device; compressing the event data provided from the pixel array with the encoding unit by using the determined compression scheme; transmitting the compressed event data from the encoding unit to a processing unit; carrying out predetermined processing on the compressed event data with the processing unit; and providing feedback information about the results of the predetermined processing from the processing unit to the control unit. Here, the control unit is configured to use the feedback information to determine the compression scheme to be used.

By selecting a compression mode for event data that are to be used as input for a predetermined processing according to the results of this predetermined processing, it can be ensured that data input for the predetermined processing is optimized for the task at hand. In particular, it can be ensured that the compressed data come in an optimized format. Further, only those parts of the original data may be provided to the predetermined processing that are truly necessary for the processing, while unnecessary or redundant information is removed. This makes the communication between the vision sensor that generates the event data and the processing unit that carries out the predetermined processing more efficient. In combination, providing tailor-made data as input for the predetermined processing as well as omitting transfer of unnecessary/redundant data saves computing power, reduces the latency, and reduces in turn the energy consumption of the device.

### BRIEF DESCRIPTION OF DRAWINGS

FIG. 1 is a schematic diagram of a sensor device.

FIG. 2 is a schematic block diagram of a sensor section.

FIG. 3 is a schematic block diagram of a pixel array section.

FIG. 4 is a schematic circuit diagram of a pixel block.

FIG. 5 is a schematic block diagram illustrating of an event detecting section.

FIG. 6 is a schematic circuit diagram of a current-voltage converting section.

FIG. 7 is a schematic circuit diagram of a subtraction section and a quantization section.

FIG. 8 is a schematic diagram of a frame data generation method based on event data.

FIG. 9 is a schematic block diagram of another quantization section.

FIG. 10 is a schematic diagram of another event detecting section.

FIG. 11 is a schematic block diagram of another pixel array section.

FIG. 12 is a schematic circuit diagram of another pixel block.

FIG. 13 is a schematic block diagram of a scan-type sensor device.

FIG. 14 is a schematic block diagram of a sensor device.

FIG. 15 is a schematic illustration of a process for selecting a region of interest.

FIG. 16 provides schematic illustrations of processes for determining readout times.

FIGS. 17A and 17B are schematic block diagrams of further sensor devices.

FIG. 18 is another schematic illustration of a sensor device.

FIG. 19 is a schematic illustration of event representations.

FIG. 20 is a schematic illustration of another sensor device.

FIG. 21 is a schematic illustration of a neural network architecture used in a sensor device.

FIG. 22 is an illustration of a schematic process flow of a method for operating a sensor device.

FIG. 23 is a schematic block diagram of a vehicle control system.

FIG. 24 is a diagram of assistance in explaining an example of installation positions of an outside-vehicle information detecting section and an imaging section.

FIGS. 25A and 25B are schematic illustrations of a mobile device and a head mounted display comprising a sensor device.

### DETAILED DESCRIPTION

The present disclosure is directed to mitigating problems related to processing of data of imaging sensors. The solutions to these problems discussed below are applicable to all according sensor types. They are particularly relevant for event based/dynamic vision sensors, EVS/DVS, since the sparsity of the sensor data generated for these sensors combined with their high output rate allows particular improvements of the efficiency of processing these data. In order to simplify the description and also in order to cover an important application example, the present description is focused therefore without prejudice on EVS/DVS. However, it has to be understood that although in the following reference will be made to the circuitry of EVS/DVS, the discussed solutions can be applied in principle to all pixel-based sensor devices. The discussed sensor devices may be implemented in any imaging sensor setup such as e.g. smartphone cameras, scientific devices, automotive video sensors or the like.

First, a possible implementation of an EVS/DVS will be described. This is of course purely exemplary. It is to be understood that EVSs/DVSs could also be implemented differently.

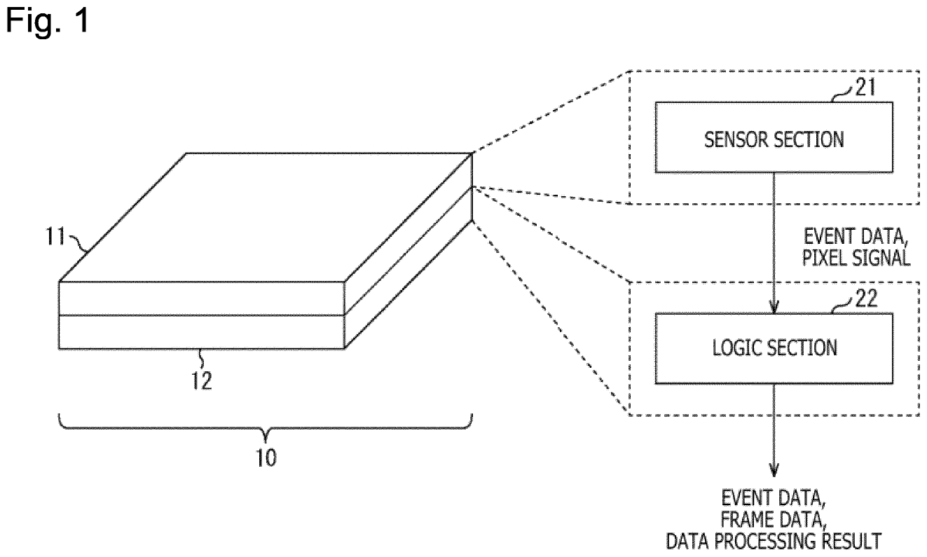

FIG. 1 is a diagram illustrating a configuration example of a sensor device 10, which is in the example of FIG. 1 constituted by a sensor chip.

The sensor device 10 is a single-chip semiconductor chip and includes a sensor die (substrate) 11, which serves as a plurality of dies (substrates), and a logic die 12 that are stacked. Note that, the sensor device can also include only a single die or three or more stacked dies.

In the sensor device 10 of FIG. 1, the sensor die 11 includes (a circuit serving as) a sensor section 21, and the logic die 12 includes a logic section 22. Note that, the sensor section 21 can be partly formed on the logic die 12. Further, the logic section 22 can be partly formed on the sensor die 11.

The sensor section 21 includes pixels configured to perform photoelectric conversion on incident light to generate electrical signals, and generates event data indicating the occurrence of events that are changes in the electrical signal of the pixels. The sensor section 21 supplies the event data to the logic section 22. That is, the sensor section 21 performs imaging of performing, in the pixels, photoelectric conversion on incident light to generate electrical signals, similarly to a synchronous image sensor, for example. The sensor section 21, however, generates event data indicating the occurrence of events that are changes in the electrical signal of the pixels instead of generating image data in a frame format (frame data). The sensor section 21 outputs, to the logic section 22, the event data obtained by the imaging.

Here, the synchronous image sensor is an image sensor configured to perform imaging in synchronization with a vertical synchronization signal and output frame data that is image data in a frame format. The sensor section 21 can be regarded as asynchronous (an asynchronous image sensor) in contrast to the synchronous image sensor, since the sensor section 21 does not operate in synchronization with a vertical synchronization signal when outputting event data. In particular, the sensor section 21 can output event data with a temporal precision of 10⁻⁶ s.

Note that, the sensor section 21 may generate and output, other than event data, frame data, similarly to the synchronous image sensor. In addition, the sensor section 21 can output, together with event data, electrical signals of pixels in which events have occurred, as pixel signals that are pixel values of the pixels in frame data.

The logic section 22 controls the sensor section 21 as needed. Further, the logic section 22 performs various types of data processing, such as data processing of generating frame data on the basis of event data from the sensor section 21 and image processing on frame data from the sensor section 21 or frame data generated on the basis of the event data from the sensor section 21, and outputs data processing results obtained by performing the various types of data processing on the event data and the frame data. The logic section 22 may implement the functions of a control unit as described below.

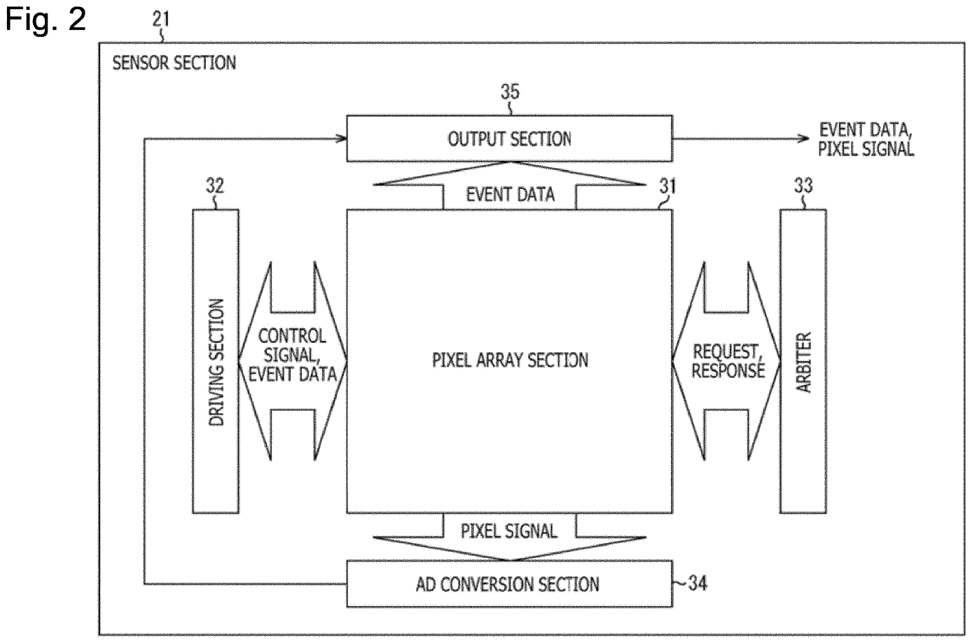

FIG. 2 is a block diagram illustrating a configuration example of the sensor section 21 of FIG. 1.

The sensor section 21 includes a pixel array section 31, a driving section 32, an arbiter 33, an AD (Analog to Digital) conversion section 34, and an output section 35.

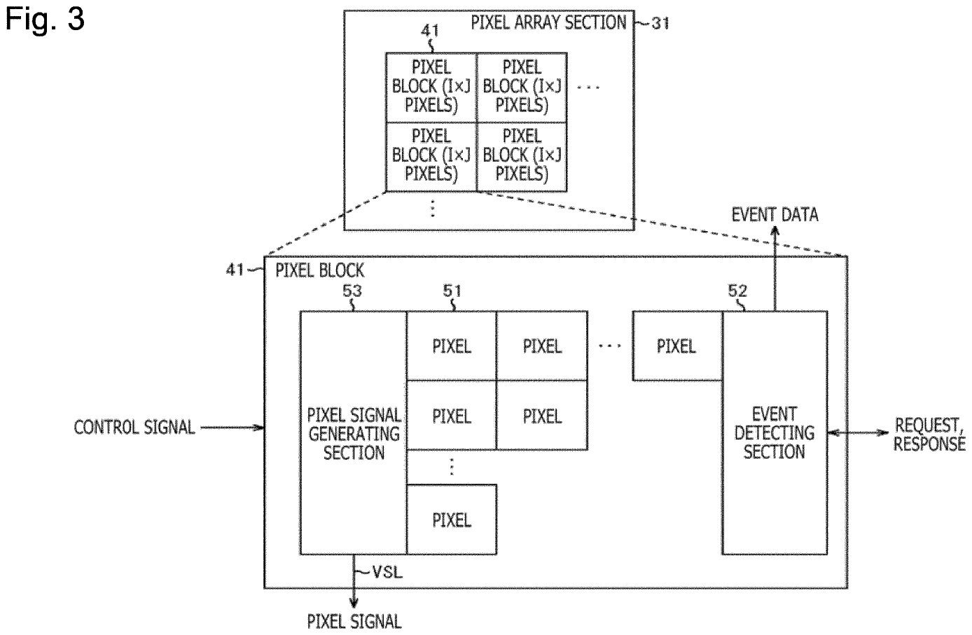

The pixel array section 31 includes a plurality of pixels 51 (FIG. 3) arrayed in a two-dimensional lattice pattern. The pixel array section 31 detects, in a case where a change larger than a predetermined threshold (including a change equal to or larger than the threshold as needed) has occurred in (a voltage corresponding to) a photocurrent that is an electrical signal generated by photoelectric conversion in the pixel 51, the change in the photocurrent as an event. In a case of detecting an event, the pixel array section 31 outputs, to the arbiter 33, a request for requesting the output of event data indicating the occurrence of the event. Then, in a case of receiving a response indicating event data output permission from the arbiter 33, the pixel array section 31 outputs the event data to the driving section 32 and the output section 35. In addition, the pixel array section 31 may output an electrical signal of the pixel 51 in which the event has been detected to the AD conversion section 34.

The driving section 32 supplies control signals to the pixel array section 31 to drive the pixel array section 31. For example, the driving section 32 drives the pixel 51 regarding which the pixel array section 31 has output event data, so that the pixel 51 in question supplies (outputs) a pixel signal to the AD conversion section 34.

The arbiter 33 arbitrates the requests for requesting the output of event data from the pixel array section 31, and returns responses indicating event data output permission or prohibition to the pixel array section 31.

The AD conversion section 34 includes, for example, a single-slope ADC (AD converter) (not illustrated) in each column of pixel blocks 41 (FIG. 3) described later, for example. The AD conversion section 34 performs, with the ADC in each column, AD conversion on pixel signals of the pixels 51 of the pixel blocks 41 in the column, and supplies the resultant to the output section 35. Note that, the AD conversion section 34 can perform CDS (Correlated Double Sampling) together with pixel signal AD conversion.

The output section 35 performs necessary processing on the pixel signals from the AD conversion section 34 and the event data from the pixel array section 31 and supplies the resultant to the logic section 22 (FIG. 1).

Here, a change in the photocurrent generated in the pixel 51 can be recognized as a change in the amount of light entering the pixel 51, so that it can also be said that an event is a change in light amount (a change in light amount larger than the threshold) in the pixel 51.

Event data indicating the occurrence of an event at least includes location information (coordinates or the like) indicating the location of a pixel block in which a change in light amount, which is the event, has occurred. Besides, the event data can also include the polarity (positive or negative) of the change in light amount.

With regard to the series of event data that is output from the pixel array section 31 at timings at which events have occurred, it can be said that, as long as the event data interval is the same as the event occurrence interval, the event data implicitly includes time point information indicating (relative) time points at which the events have occurred. However, for example, when the event data is stored in a memory and the event data interval is no longer the same as the event occurrence interval, the time point information implicitly included in the event data is lost. Thus, the output section 35 includes, in event data, time point information indicating (relative) time points at which events have occurred, such as timestamps, before the event data interval is changed from the event occurrence interval. The processing of including time point information in event data can be performed in any block other than the output section 35 as long as the processing is performed before time point information implicitly included in event data is lost.

FIG. 3 is a block diagram illustrating a configuration example of the pixel array section 31 of FIG. 2.

The pixel array section 31 includes the plurality of pixel blocks 41. The pixel block 41 includes the I×J pixels 51 that are one or more pixels arrayed in I rows and J columns (I and J are integers), an event detecting section 52, and a pixel signal generating section 53. The one or more pixels 51 in the pixel block 41 share the event detecting section 52 and the pixel signal generating section 53. Further, in each column of the pixel blocks 41, a VSL (Vertical Signal Line) for connecting the pixel blocks 41 to the ADC of the AD conversion section 34 is wired.

The pixel 51 receives light incident from an object and performs photoelectric conversion to generate a photocurrent serving as an electrical signal. The pixel 51 supplies the photocurrent to the event detecting section 52 under the control of the driving section 32.

The event detecting section 52 detects, as an event, a change larger than the predetermined threshold in photocurrent from each of the pixels 51, under the control of the driving section 32. In a case of detecting an event, the event detecting section 52 supplies, to the arbiter 33 (FIG. 2), a request for requesting the output of event data indicating the occurrence of the event. Then, when receiving a response indicating event data output permission to the request from the arbiter 33, the event detecting section 52 outputs the event data to the driving section 32 and the output section 35.

The pixel signal generating section 53 generates, in the case where the event detecting section 52 has detected an event, a voltage corresponding to a photocurrent from the pixel 51 as a pixel signal, and supplies the voltage to the AD conversion section 34 through the VSL, under the control of the driving section 32.

Here, detecting a change larger than the predetermined threshold in photocurrent as an event can also be recognized as detecting, as an event, absence of change larger than the predetermined threshold in photocurrent. The pixel signal generating section 53 can generate a pixel signal in the case where absence of change larger than the predetermined threshold in photocurrent has been detected as an event as well as in the case where a change larger than the predetermined threshold in photocurrent has been detected as an event.

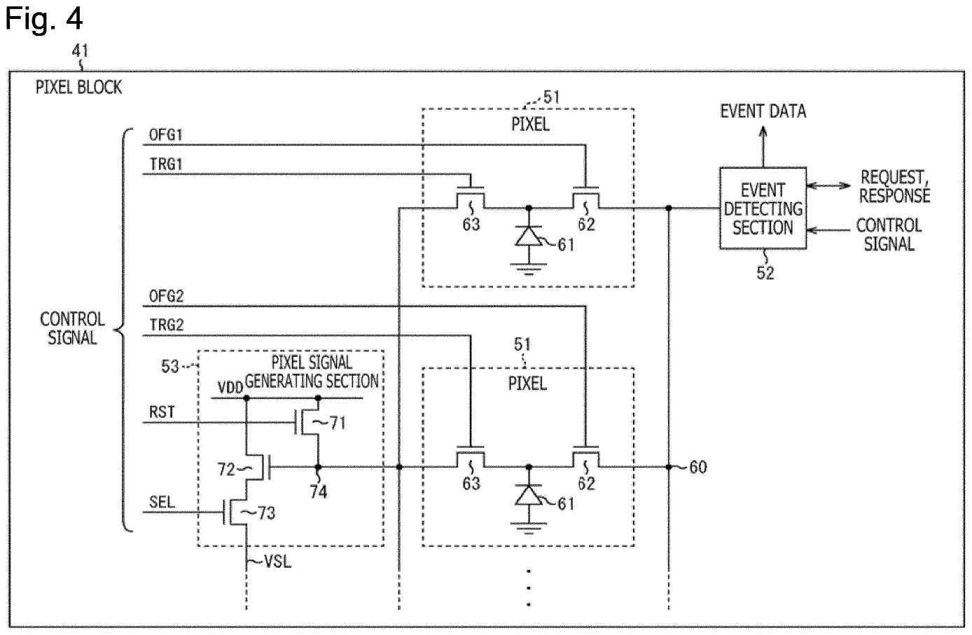

FIG. 4 is a circuit diagram illustrating a configuration example of the pixel block 41.

The pixel block 41 includes, as described with reference to FIG. 3, the pixels 51, the event detecting section 52, and the pixel signal generating section 53.

The pixel 51 includes a photoelectric conversion element 61 and transfer transistors 62 and 63.

The photoelectric conversion element 61 includes, for example, a PD (Photodiode). The photoelectric conversion element 61 receives incident light and performs photoelectric conversion to generate charges.

The transfer transistor 62 includes, for example, an N (Negative)-type MOS (Metal-Oxide-Semiconductor) FET (Field Effect Transistor). The transfer transistor 62 of the n-th pixel 51 of the I×J pixels 51 in the pixel block 41 is turned on or off in response to a control signal OFGn supplied from the driving section 32 (FIG. 2). When the transfer transistor 62 is turned on, charges generated in the photoelectric conversion element 61 are transferred (supplied) to the event detecting section 52, as a photocurrent.

The transfer transistor 63 includes, for example, an N-type MOSFET. The transfer transistor 63 of the n-th pixel 51 of the I×J pixels 51 in the pixel block 41 is turned on or off in response to a control signal TRGn supplied from the driving section 32. When the transfer transistor 63 is turned on, charges generated in the photoelectric conversion element 61 are transferred to an FD 74 of the pixel signal generating section 53.

The I×J pixels 51 in the pixel block 41 are connected to the event detecting section 52 of the pixel block 41 through nodes 60. Thus, photocurrents generated in (the photoelectric conversion elements 61 of) the pixels 51 are supplied to the event detecting section 52 through the nodes 60. As a result, the event detecting section 52 receives the sum of photocurrents from all the pixels 51 in the pixel block 41. Thus, the event detecting section 52 detects, as an event, a change in sum of photocurrents supplied from the I×J pixels 51 in the pixel block 41.

The pixel signal generating section 53 includes a reset transistor 71, an amplification transistor 72, a selection transistor 73, and the FD (Floating Diffusion) 74.

The reset transistor 71, the amplification transistor 72, and the selection transistor 73 include, for example, N-type MOSFETs.

The reset transistor 71 is turned on or off in response to a control signal RST supplied from the driving section 32 (FIG. 2). When the reset transistor 71 is turned on, the FD 74 is connected to a power supply VDD, and charges accumulated in the FD 74 are thus discharged to the power supply VDD. With this, the FD 74 is reset.

The amplification transistor 72 has a gate connected to the FD 74, a drain connected to the power supply VDD, and a source connected to the VSL through the selection transistor 73. The amplification transistor 72 is a source follower and outputs a voltage (electrical signal) corresponding to the voltage of the FD 74 supplied to the gate to the VSL through the selection transistor 73.

The selection transistor 73 is turned on or off in response to a control signal SEL supplied from the driving section 32. When the selection transistor 73 is turned on, a voltage corresponding to the voltage of the FD 74 from the amplification transistor 72 is output to the VSL.

The FD 74 accumulates charges transferred from the photoelectric conversion elements 61 of the pixels 51 through the transfer transistors 63, and converts the charges to voltages.

With regard to the pixels 51 and the pixel signal generating section 53, which are configured as described above, the driving section 32 turns on the transfer transistors 62 with control signals OFGn, so that the transfer transistors 62 supply, to the event detecting section 52, photocurrents based on charges generated in the photoelectric conversion elements 61 of the pixels 51. With this, the event detecting section 52 receives a current that is the sum of the photocurrents from all the pixels 51 in the pixel block 41, which might also be only a single pixel.

When the event detecting section 52 detects, as an event, a change in photocurrent (sum of photocurrents) in the pixel block 41, the driving section 32 turns off the transfer transistors 62 of all the pixels 51 in the pixel block 41, to thereby stop the supply of the photocurrents to the event detecting section 52. Then, the driving section 32 sequentially turns on, with the control signals TRGn, the transfer transistors 63 of the pixels 51 in the pixel block 41 in which the event has been detected, so that the transfer transistors 63 transfers charges generated in the photoelectric conversion elements 61 to the FD 74. The FD 74 accumulates the charges transferred from (the photoelectric conversion elements 61 of) the pixels 51. Voltages corresponding to the charges accumulated in the FD 74 are output to the VSL, as pixel signals of the pixels 51, through the amplification transistor 72 and the selection transistor 73.

As described above, in the sensor section 21 (FIG. 2), only pixel signals of the pixels 51 in the pixel block 41 in which an event has been detected are sequentially output to the VSL. The pixel signals output to the VSL are supplied to the AD conversion section 34 to be subjected to AD conversion.

Here, in the pixels 51 in the pixel block 41, the transfer transistors 63 can be turned on not sequentially but simultaneously. In this case, the sum of pixel signals of all the pixels 51 in the pixel block 41 can be output.

In the pixel array section 31 of FIG. 3, the pixel block 41 includes one or more pixels 51, and the one or more pixels 51 share the event detecting section 52 and the pixel signal generating section 53. Thus, in the case where the pixel block 41 includes a plurality of pixels 51, the numbers of the event detecting sections 52 and the pixel signal generating sections 53 can be reduced as compared to a case where the event detecting section 52 and the pixel signal generating section 53 are provided for each of the pixels 51, with the result that the scale of the pixel array section 31 can be reduced.

Note that, in the case where the pixel block 41 includes a plurality of pixels 51, the event detecting section 52 can be provided for each of the pixels 51. In the case where the plurality of pixels 51 in the pixel block 41 share the event detecting section 52, events are detected in units of the pixel blocks 41. In the case where the event detecting section 52 is provided for each of the pixels 51, however, events can be detected in units of the pixels 51.

Yet, even in the case where the plurality of pixels 51 in the pixel block 41 share the single event detecting section 52, events can be detected in units of the pixels 51 when the transfer transistors 62 of the plurality of pixels 51 are temporarily turned on in a time-division manner.

Further, in a case where there is no need to output pixel signals, the pixel block 41 can be formed without the pixel signal generating section 53. In the case where the pixel block 41 is formed without the pixel signal generating section 53, the sensor section 21 can be formed without the AD conversion section 34 and the transfer transistors 63. In this case, the scale of the sensor section 21 can be reduced. The sensor will then output the address of the pixel (block) in which the event occurred, if necessary with a time stamp.

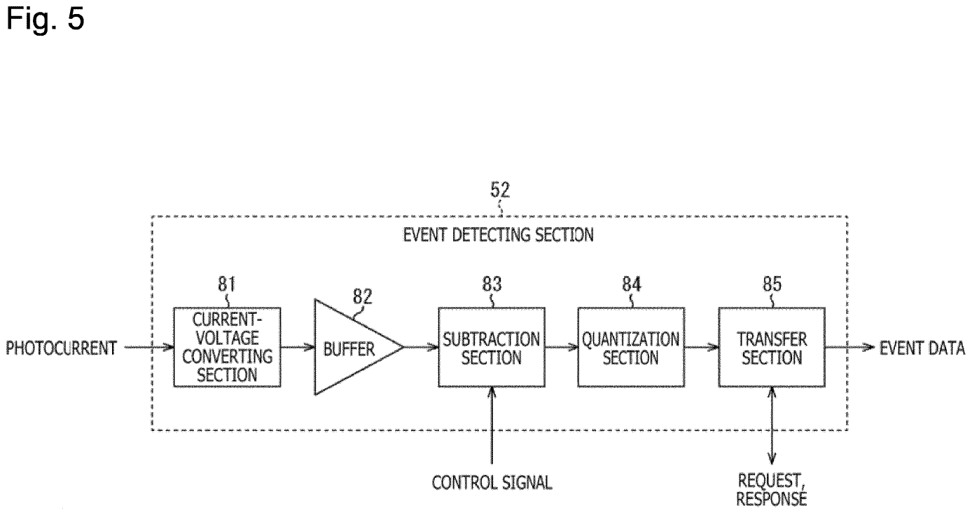

FIG. 5 is a block diagram illustrating a configuration example of the event detecting section 52 of FIG. 3.

The event detecting section 52 includes a current-voltage converting section 81, a buffer 82, a subtraction section 83, a quantization section 84, and a transfer section 85.

The current-voltage converting section 81 converts (a sum of) photocurrents from the pixels 51 to voltages corresponding to the logarithms of the photocurrents (hereinafter also referred to as a “photovoltage”) and supplies the voltages to the buffer 82.

The buffer 82 buffers photovoltages from the current-voltage converting section 81 and supplies the resultant to the subtraction section 83.

The subtraction section 83 calculates, at a timing instructed by a row driving signal that is a control signal from the driving section 32, a difference between the current photovoltage and a photovoltage at a timing slightly shifted from the current time, and supplies a difference signal corresponding to the difference to the quantization section 84.

The quantization section 84 quantizes difference signals from the subtraction section 83 to digital signals and supplies the quantized values of the difference signals to the transfer section 85 as event data.

The transfer section 85 transfers (outputs), on the basis of event data from the quantization section 84, the event data to the output section 35. That is, the transfer section 85 supplies a request for requesting the output of the event data to the arbiter 33. Then, when receiving a response indicating event data output permission to the request from the arbiter 33, the transfer section 85 outputs the event data to the output section 35.

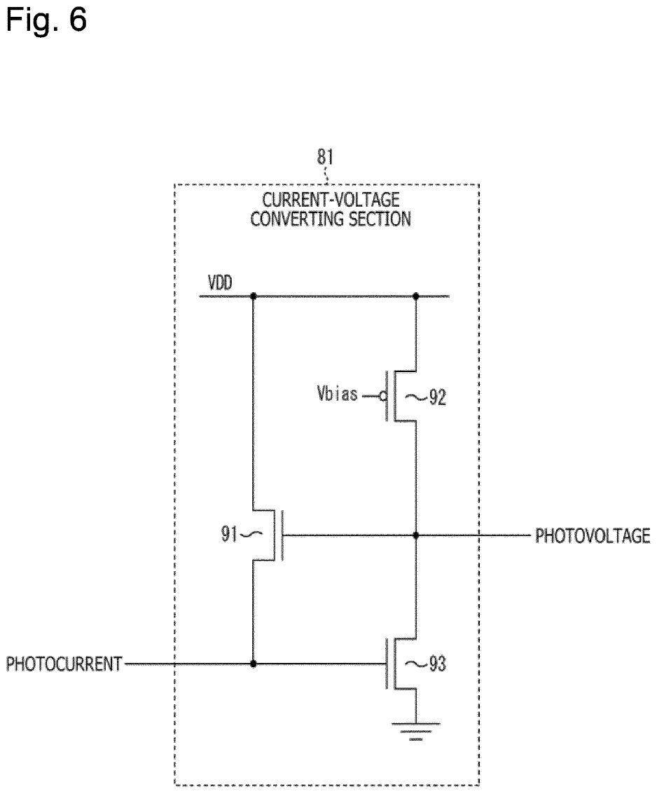

FIG. 6 is a circuit diagram illustrating a configuration example of the current-voltage converting section 81 of FIG. 5.

The current-voltage converting section 81 includes transistors 91 to 93. As the transistors 91 and 93, for example, N-type MOSFETs can be employed. As the transistor 92, for example, a P-type MOSFET can be employed.

The transistor 91 has a source connected to the gate of the transistor 93, and a photocurrent is supplied from the pixel 51 to the connecting point between the source of the transistor 91 and the gate of the transistor 93. The transistor 91 has a drain connected to the power supply VDD and a gate connected to the drain of the transistor 93.

The transistor 92 has a source connected to the power supply VDD and a drain connected to the connecting point between the gate of the transistor 91 and the drain of the transistor 93. A predetermined bias voltage Vbias is applied to the gate of the transistor 92. With the bias voltage Vbias, the transistor 92 is turned on or off, and the operation of the current-voltage converting section 81 is turned on or off depending on whether the transistor 92 is turned on or off.

The source of the transistor 93 is grounded.

In the current-voltage converting section 81, the transistor 91 has the drain connected on the power supply VDD side. The source of the transistor 91 is connected to the pixels 51 (FIG. 4), so that photocurrents based on charges generated in the photoelectric conversion elements 61 of the pixels 51 flow through the transistor 91 (from the drain to the source). The transistor 91 operates in a subthreshold region, and at the gate of the transistor 91, photovoltages corresponding to the logarithms of the photocurrents flowing through the transistor 91 are generated. As described above, in the current-voltage converting section 81, the transistor 91 converts photocurrents from the pixels 51 to photovoltages corresponding to the logarithms of the photocurrents.

In the current-voltage converting section 81, the transistor 91 has the gate connected to the connecting point between the drain of the transistor 92 and the drain of the transistor 93, and the photovoltages are output from the connecting point in question.

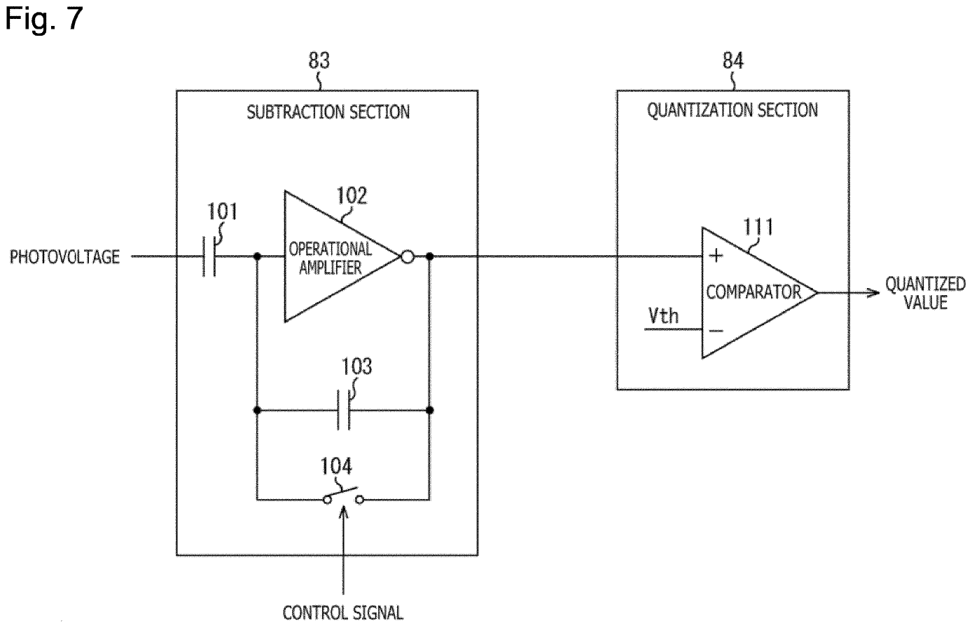

FIG. 7 is a circuit diagram illustrating configuration examples of the subtraction section 83 and the quantization section 84 of FIG. 5.

The subtraction section 83 includes a capacitor 101, an operational amplifier 102, a capacitor 103, and a switch 104. The quantization section 84 includes a comparator 111.

The capacitor 101 has one end connected to the output terminal of the buffer 82 (FIG. 5) and the other end connected to the input terminal (inverting input terminal) of the operational amplifier 102. Thus, photovoltages are input to the input terminal of the operational amplifier 102 through the capacitor 101.

The operational amplifier 102 has an output terminal connected to the non-inverting input terminal (+) of the comparator 111.

The capacitor 103 has one end connected to the input terminal of the operational amplifier 102 and the other end connected to the output terminal of the operational amplifier 102.

The switch 104 is connected to the capacitor 103 to switch the connections between the ends of the capacitor 103. The switch 104 is turned on or off in response to a row driving signal that is a control signal from the driving section 32, to thereby switch the connections between the ends of the capacitor 103.

A photovoltage on the buffer 82 (FIG. 5) side of the capacitor 101 when the switch 104 is on is denoted by Vinit, and the capacitance (electrostatic capacitance) of the capacitor 101 is denoted by C1. The input terminal of the operational amplifier 102 serves as a virtual ground terminal, and a charge Qinit that is accumulated in the capacitor 101 in the case where the switch 104 is on is expressed by Expression (1).

$$Qinit = C 1 \times Vinit \qquad ( 1 )$$

Further, in the case where the switch 104 is on, the connection between the ends of the capacitor 103 is cut (short-circuited), so that no charge is accumulated in the capacitor 103.

When a photovoltage on the buffer 82 (FIG. 5) side of the capacitor 101 in the case where the switch 104 has thereafter been turned off is denoted by Vafter, a charge Qafter that is accumulated in the capacitor 101 in the case where the switch 104 is off is expressed by Expression (2).

$$Qafter = C 1 \times Vafter \qquad ( 2 )$$

When the capacitance of the capacitor 103 is denoted by C2 and the output voltage of the operational amplifier 102 is denoted by Vout, a charge Q2 that is accumulated in the capacitor 103 is expressed by Expression (3).

$$Q 2 = - C 2 \times Vout \qquad ( 3 )$$

Since the total amount of charges in the capacitors 101 and 103 does not change before and after the switch 104 is turned off, Expression (4) is established.

$$Qinit = Qafter + Q 2 \qquad ( 4 )$$

When Expression (1) to Expression (3) are substituted for Expression (4), Expression (5) is obtained.

$$Vout = - ( C 1 / C 2 ) \times ( Vafter - Vinit ) \qquad ( 5 )$$

With Expression (5), the subtraction section 83 subtracts the photovoltage Vinit from the photovoltage Vafter, that is, calculates the difference signal (Vout) corresponding to a difference Vafter−Vinit between the photovoltages Vafter and Vinit. With Expression (5), the subtraction gain of the subtraction section 83 is C1/C2. Since the maximum gain is normally desired, C1 is preferably set to a large value and C2 is preferably set to a small value. Meanwhile, when C2 is too small, kTC noise increases, resulting in a risk of deteriorated noise characteristics. Thus, the capacitance C2 can only be reduced in a range that achieves acceptable noise. Further, since the pixel blocks 41 each have installed therein the event detecting section 52 including the subtraction section 83, the capacitances C1 and C2 have space constraints. In consideration of these matters, the values of the capacitances C1 and C2 are determined.

The comparator 111 compares a difference signal from the subtraction section 83 with a predetermined threshold (voltage) Vth (>0) applied to the inverting input terminal (−), thereby quantizing the difference signal. The comparator 111 outputs the quantized value obtained by the quantization to the transfer section 85 as event data.

For example, in a case where a difference signal is larger than the threshold Vth, the comparator 111 outputs an H (High) level indicating 1, as event data indicating the occurrence of an event. In a case where a difference signal is not larger than the threshold Vth, the comparator 111 outputs an L (Low) level indicating 0, as event data indicating that no event has occurred.

The transfer section 85 supplies a request to the arbiter 33 in a case where it is confirmed on the basis of event data from the quantization section 84 that a change in light amount that is an event has occurred, that is, in the case where the difference signal (Vout) is larger than the threshold Vth. When receiving a response indicating event data output permission, the transfer section 85 outputs the event data indicating the occurrence of the event (for example, H level) to the output section 35.

The output section 35 includes, in event data from the transfer section 85, location/address information regarding (the pixel block 41 including) the pixel 51 in which an event indicated by the event data has occurred and time point information indicating a time point at which the event has occurred, and further, as needed, the polarity of a change in light amount that is the event, i.e. whether the intensity did increase or decrease. The output section 35 outputs the event data.

As the data format of event data including location information regarding the pixel 51 in which an event has occurred, time point information indicating a time point at which the event has occurred, and the polarity of a change in light amount that is the event, for example, the data format called “AER (Address Event Representation)” can be employed.

Note that, a gain A of the entire event detecting section 52 is expressed by the following expression where the gain of the current-voltage converting section 81 is denoted by CG_{log} and the gain of the buffer 82 is 1.

$$A = {CG}_{log} C 1 / C 2 ( \sum {i}_{photo} \_n ) \qquad ( 6 )$$

Here, iₚₕₒₜₒ_n denotes a photocurrent of the n-th pixel 51 of the I×J pixels 51 in the pixel block 41. In Expression (6), Σ denotes the summation of n that takes integers ranging from 1 to I×J.

Note that, the pixel 51 can receive any light as incident light with an optical filter through which predetermined light passes, such as a color filter. For example, in a case where the pixel 51 receives visible light as incident light, event data indicates the occurrence of changes in pixel value in images including visible objects. Further, for example, in a case where the pixel 51 receives, as incident light, infrared light, millimeter waves, or the like for ranging, event data indicates the occurrence of changes in distances to objects. In addition, for example, in a case where the pixel 51 receives infrared light for temperature measurement, as incident light, event data indicates the occurrence of changes in temperature of objects. In the present embodiment, the pixel 51 is assumed to receive visible light as incident light.

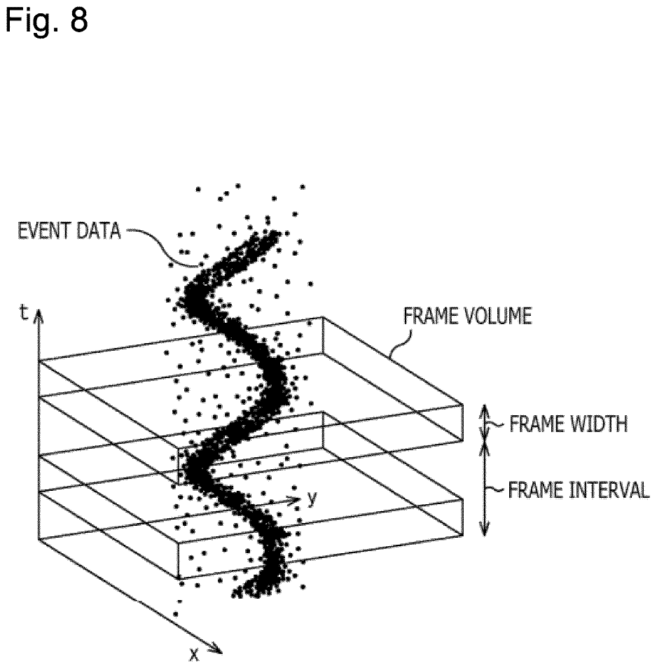

FIG. 8 is a diagram illustrating an example of a frame data generation method based on event data.

The logic section 22 sets a frame interval and a frame width on the basis of an externally input command, for example. Here, the frame interval represents the interval of frames of frame data that is generated on the basis of event data. The frame width represents the time width of event data that is used for generating frame data on a single frame. A frame interval and a frame width that are set by the logic section 22 are also referred to as a “set frame interval” and a “set frame width,” respectively.

The logic section 22 generates, on the basis of the set frame interval, the set frame width, and event data from the sensor section 21, frame data that is image data in a frame format, to thereby convert the event data to the frame data.

That is, the logic section 22 generates, in each set frame interval, frame data on the basis of event data in the set frame width from the beginning of the set frame interval.

Here, it is assumed that event data includes time point information tᵢ indicating a time point at which an event has occurred (hereinafter also referred to as an “event time point”) and coordinates (x, y) serving as location information regarding (the pixel block 41 including) the pixel 51 in which the event has occurred (hereinafter also referred to as an “event location”).

In FIG. 8, in a three-dimensional space (time and space) with the x axis, the y axis, and the time axis t, points representing event data are plotted on the basis of the event time point t and the event location (coordinates) (x, y) included in the event data.

That is, when a location (x, y, t) on the three-dimensional space indicated by the event time point t and the event location (x, y) included in event data is regarded as the space-time location of an event, in FIG. 8, the points representing the event data are plotted on the space-time locations (x, y, t) of the events.

The logic section 22 starts to generate frame data on the basis of event data by using, as a generation start time point at which frame data generation starts, a predetermined time point, for example, a time point at which frame data generation is externally instructed or a time point at which the sensor device 10 is powered on.

Here, cuboids each having the set frame width in the direction of the time axis t in the set frame intervals, which appear from the generation start time point, are referred to as a “frame volume.” The size of the frame volume in the x-axis direction or the y-axis direction is equal to the number of the pixel blocks 41 or the pixels 51 in the x-axis direction or the y-axis direction, for example.

The logic section 22 generates, in each set frame interval, frame data on a single frame on the basis of event data in the frame volume having the set frame width from the beginning of the set frame interval.

Frame data can be generated by, for example, setting white to a pixel (pixel value) in a frame at the event location (x, y) included in event data and setting a predetermined color such as gray to pixels at other locations in the frame.

Besides, in a case where event data includes the polarity of a change in light amount that is an event, frame data can be generated in consideration of the polarity included in the event data. For example, white can be set to pixels in the case a positive polarity, while black can be set to pixels in the case of a negative polarity.

In addition, in the case where pixel signals of the pixels 51 are also output when event data is output as described with reference to FIG. 3 and FIG. 4, frame data can be generated on the basis of the event data by using the pixel signals of the pixels 51. That is, frame data can be generated by setting, in a frame, a pixel at the event location (x, y) (in a block corresponding to the pixel block 41) included in event data to a pixel signal of the pixel 51 at the location (x, y) and setting a predetermined color such as gray to pixels at other locations.

Note that, in the frame volume, there are a plurality of pieces of event data that are different in the event time point t but the same in the event location (x, y) in some cases. In this case, for example, event data at the latest or oldest event time point t can be prioritized. Further, in the case where event data includes polarities, the polarities of a plurality of pieces of event data that are different in the event time point t but the same in the event location (x, y) can be added together, and a pixel value based on the added value obtained by the addition can be set to a pixel at the event location (x, y).

Here, in a case where the frame width and the frame interval are the same, the frame volumes are adjacent to each other without any gap. Further, in a case where the frame interval is larger than the frame width, the frame volumes are arranged with gaps. In a case where the frame width is larger than the frame interval, the frame volumes are arranged to be partly overlapped with each other.

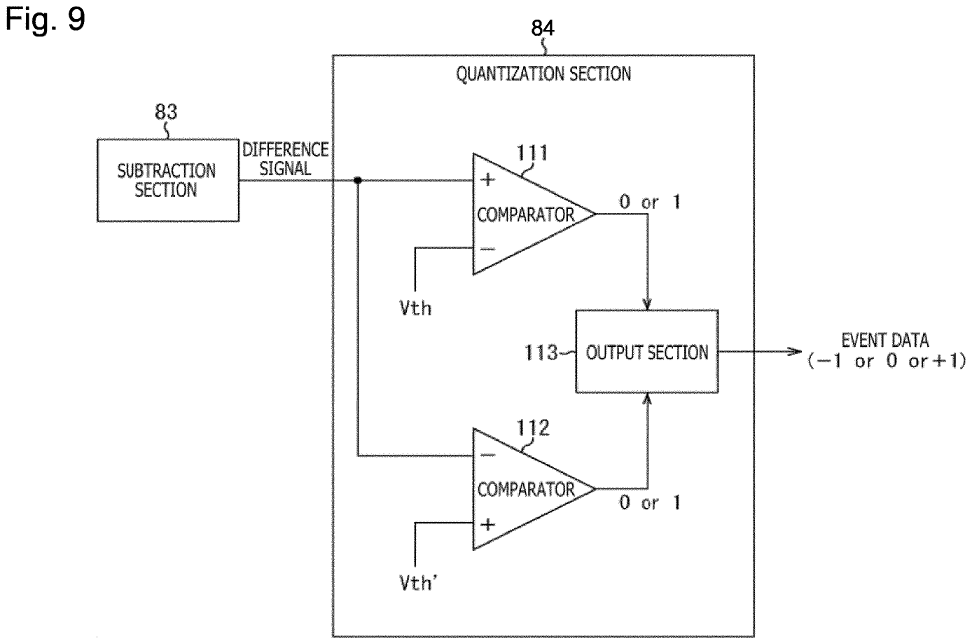

FIG. 9 is a block diagram illustrating another configuration example of the quantization section 84 of FIG. 5.

Note that, in FIG. 9, parts corresponding to those in the case of FIG. 7 are denoted by the same reference signs, and the description thereof is omitted as appropriate below.

In FIG. 9, the quantization section 84 includes comparators 111 and 112 and an output section 113.

Thus, the quantization section 84 of FIG. 9 is similar to the case of FIG. 7 in including the comparator 111. However, the quantization section 84 of FIG. 9 is different from the case of FIG. 7 in newly including the comparator 112 and the output section 113.

The event detecting section 52 (FIG. 5) including the quantization section 84 of FIG. 9 detects, in addition to events, the polarities of changes in light amount that are events.

In the quantization section 84 of FIG. 9, the comparator 111 outputs, in the case where a difference signal is larger than the threshold Vth, the H level indicating 1, as event data indicating the occurrence of an event having the positive polarity. The comparator 111 outputs, in the case where a difference signal is not larger than the threshold Vth, the L level indicating 0, as event data indicating that no event having the positive polarity has occurred.

Further, in the quantization section 84 of FIG. 9, a threshold Vth′ (<Vth) is supplied to the non-inverting input terminal (+) of the comparator 112, and difference signals are supplied to the inverting input terminal (−) of the comparator 112 from the subtraction section 83. Here, for the sake of simple description, it is assumed that the threshold Vth′ is equal to −Vth, for example, which needs however not to be the case.

The comparator 112 compares a difference signal from the subtraction section 83 with the threshold Vth′ applied to the inverting input terminal (−), thereby quantizing the difference signal. The comparator 112 outputs, as event data, the quantized value obtained by the quantization.

For example, in a case where a difference signal is smaller than the threshold Vth′ (the absolute value of the difference signal having a negative value is larger than the threshold Vth), the comparator 112 outputs the H level indicating 1, as event data indicating the occurrence of an event having the negative polarity. Further, in a case where a difference signal is not smaller than the threshold Vth′ (the absolute value of the difference signal having a negative value is not larger than the threshold Vth), the comparator 112 outputs the L level indicating 0, as event data indicating that no event having the negative polarity has occurred.

The output section 113 outputs, on the basis of event data output from the comparators 111 and 112, event data indicating the occurrence of an event having the positive polarity, event data indicating the occurrence of an event having the negative polarity, or event data indicating that no event has occurred to the transfer section 85.

For example, the output section 113 outputs, in a case where event data from the comparator 111 is the H level indicating 1, +V volts indicating +1, as event data indicating the occurrence of an event having the positive polarity, to the transfer section 85. Further, the output section 113 outputs, in a case where event data from the comparator 112 is the H level indicating 1, −V volts indicating −1, as event data indicating the occurrence of an event having the negative polarity, to the transfer section 85. In addition, the output section 113 outputs, in a case where each event data from the comparators 111 and 112 is the L level indicating 0, 0 volts (GND level) indicating 0, as event data indicating that no event has occurred, to the transfer section 85.

The transfer section 85 supplies a request to the arbiter 33 in the case where it is confirmed on the basis of event data from the output section 113 of the quantization section 84 that a change in light amount that is an event having the positive polarity or the negative polarity has occurred. After receiving a response indicating event data output permission, the transfer section 85 outputs event data indicating the occurrence of the event having the positive polarity or the negative polarity (+V volts indicating 1 or −V volts indicating −1) to the output section 35.

Preferably, the quantization section 84 has a configuration as illustrated in FIG. 9.

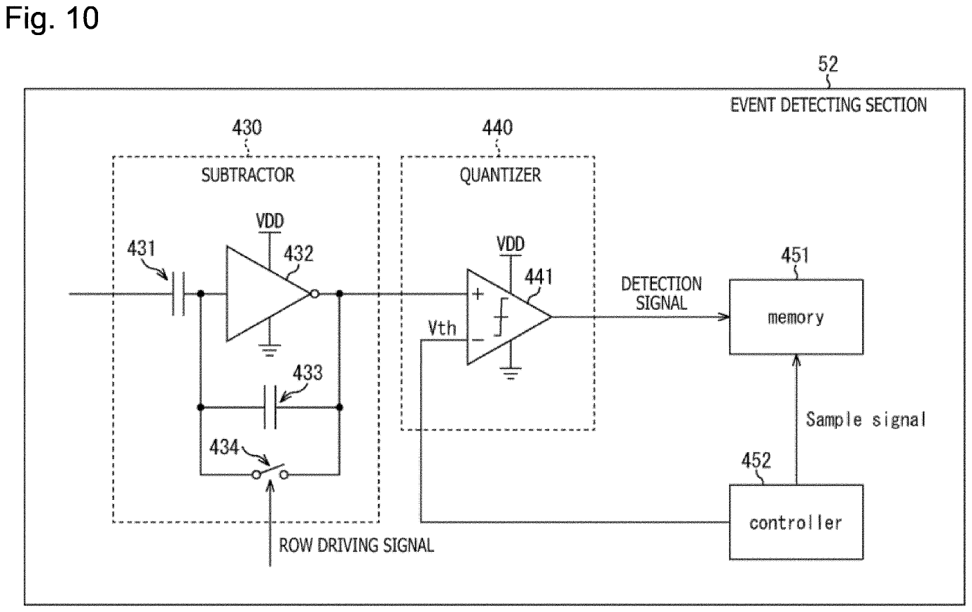

FIG. 10 is a diagram illustrating another configuration example of the event detecting section 52.

In FIG. 10, the event detecting section 52 includes a subtractor 430, a quantizer 440, a memory 451, and a controller 452. The subtractor 430 and the quantizer 440 correspond to the subtraction section 83 and the quantization section 84, respectively.

Note that, in FIG. 10, the event detecting section 52 further includes blocks corresponding to the current-voltage converting section 81 and the buffer 82, but the illustrations of the blocks are omitted in FIG. 10.

The subtractor 430 includes a capacitor 431, an operational amplifier 432, a capacitor 433, and a switch 434. The capacitor 431, the operational amplifier 432, the capacitor 433, and the switch 434 correspond to the capacitor 101, the operational amplifier 102, the capacitor 103, and the switch 104, respectively.

The quantizer 440 includes a comparator 441. The comparator 441 corresponds to the comparator 111.

The comparator 441 compares a voltage signal (difference signal) from the subtractor 430 with the predetermined threshold voltage Vth applied to the inverting input terminal (−). The comparator 441 outputs a signal indicating the comparison result, as a detection signal (quantized value).

The voltage signal from the subtractor 430 may be input to the input terminal (−) of the comparator 441, and the predetermined threshold voltage Vth may be input to the input terminal (+) of the comparator 441.

The controller 452 supplies the predetermined threshold voltage Vth applied to the inverting input terminal (−) of the comparator 441. The threshold voltage Vth which is supplied may be changed in a time-division manner. For example, the controller 452 supplies a threshold voltage Vth1 corresponding to ON events (for example, positive changes in photocurrent) and a threshold voltage Vth2 corresponding to OFF events (for example, negative changes in photocurrent) at different timings to allow the single comparator to detect a plurality of types of address events (events).

The memory 451 accumulates output from the comparator 441 on the basis of Sample signals supplied from the controller 452. The memory 451 may be a sampling circuit, such as a switch, plastic, or capacitor, or a digital memory circuit, such as a latch or flip-flop. For example, the memory 451 may hold, in a period in which the threshold voltage Vth2 corresponding to OFF events is supplied to the inverting input terminal (−) of the comparator 441, the result of comparison by the comparator 441 using the threshold voltage Vth1 corresponding to ON events. Note that, the memory 451 may be omitted, may be provided inside the pixel (pixel block 41), or may be provided outside the pixel.

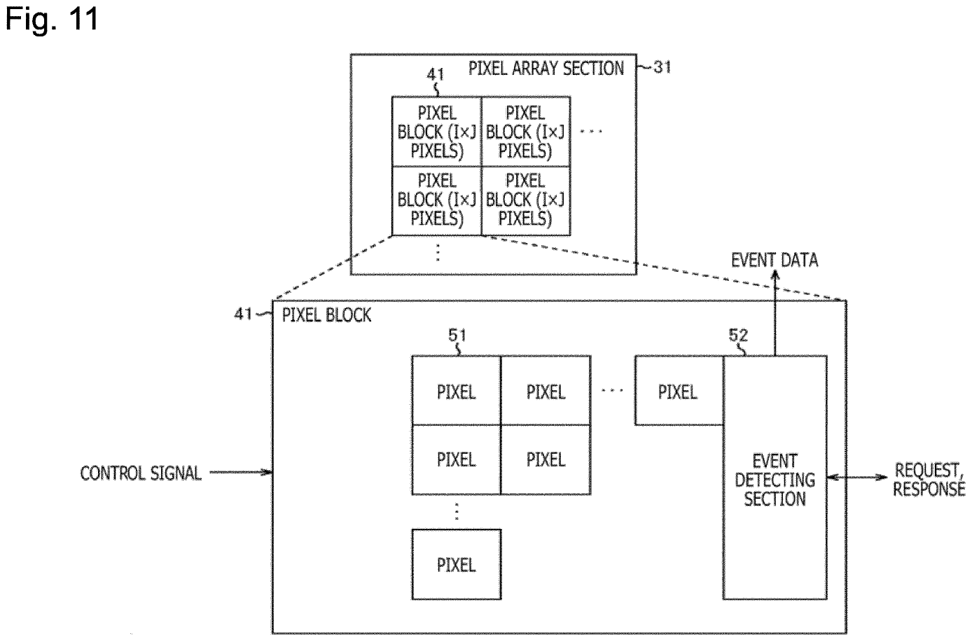

FIG. 11 is a block diagram illustrating another configuration example of the pixel array section 31 of FIG. 2.

Note that, in FIG. 11, parts corresponding to those in the case of FIG. 3 are denoted by the same reference signs, and the description thereof is omitted as appropriate below.

In FIG. 11, the pixel array section 31 includes the plurality of pixel blocks 41. The pixel block 41 includes the I×J pixels 51 that are one or more pixels and the event detecting section 52.

Thus, the pixel array section 31 of FIG. 11 is similar to the case of FIG. 3 in that the pixel array section 31 includes the plurality of pixel blocks 41 and that the pixel block 41 includes one or more pixels 51 and the event detecting section 52. However, the pixel array section 31 of FIG. 11 is different from the case of FIG. 3 in that the pixel block 41 does not include the pixel signal generating section 53.

As described above, in the pixel array section 31 of FIG. 11, the pixel block 41 does not include the pixel signal generating section 53, so that the sensor section 21 (FIG. 2) can be formed without the AD conversion section 34.

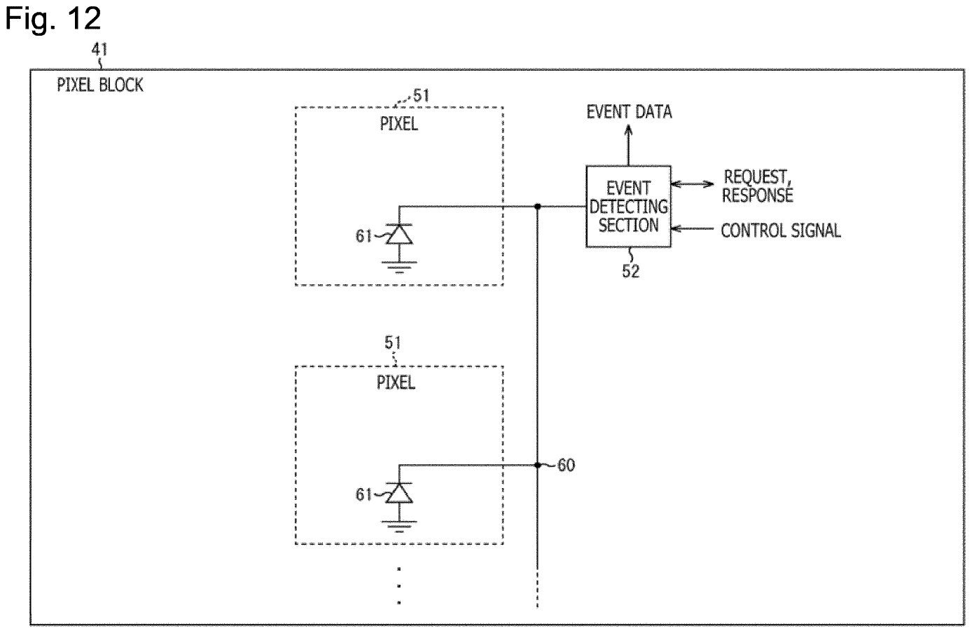

FIG. 12 is a circuit diagram illustrating a configuration example of the pixel block 41 of FIG. 11.

As described with reference to FIG. 11, the pixel block 41 includes the pixels 51 and the event detecting section 52, but does not include the pixel signal generating section 53.

In this case, the pixel 51 can only include the photoelectric conversion element 61 without the transfer transistors 62 and 63.

Note that, in the case where the pixel 51 has the configuration illustrated in FIG. 12, the event detecting section 52 can output a voltage corresponding to a photocurrent from the pixel 51, as a pixel signal.

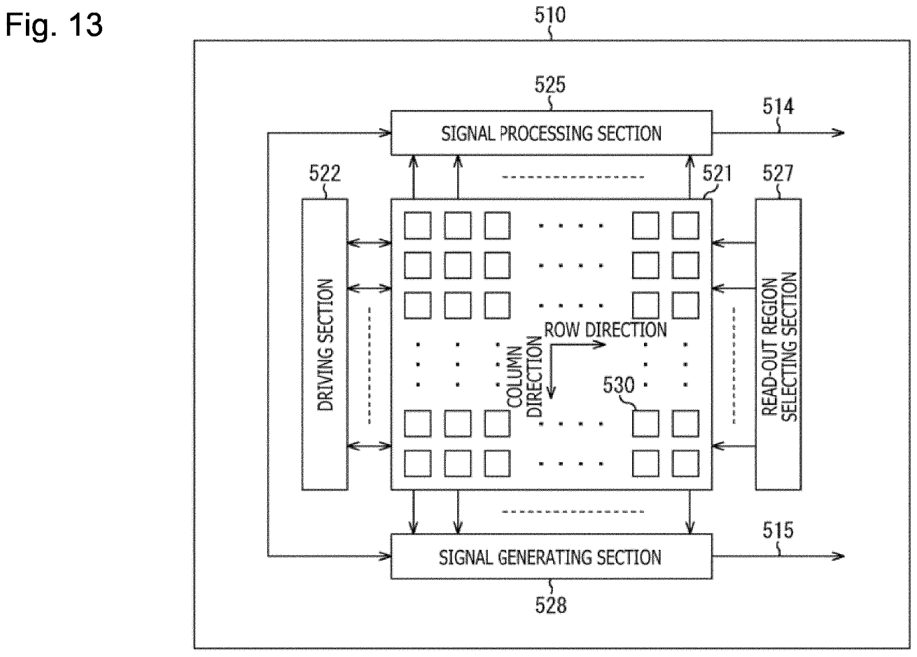

FIG. 13 is a block diagram illustrating a configuration example of a scan type imaging device which may be used as an EVS.

As illustrated in FIG. 13, an imaging device 510 includes a pixel array section 521, a driving section 522, a signal processing section 525, a read-out region selecting section 527, and an optional signal generating section 528.

The pixel array section 521 includes a plurality of pixels 530. The plurality of pixels 530 each output an output signal in response to a selection signal from the read-out region selecting section 527. The plurality of pixels 530 can each include an in-pixel quantizer as illustrated in FIG. 10, for example. The plurality of pixels 530 outputs output signals corresponding to the amounts of change in light intensity. The plurality of pixels 530 may be two-dimensionally disposed in a matrix as illustrated in FIG. 13.

The driving section 522 drives the plurality of pixels 530, so that the pixels 530 output pixel signals generated in the pixels 530 to the signal processing section 525 through an output line 514. Note that, the driving section 522 and the signal processing section 525 are circuit sections for acquiring grayscale information.

The read-out region selecting section 527 selects some of the plurality of pixels 530 included in the pixel array section 521. For example, the read-out region selecting section 527 selects one or a plurality of rows included in the two-dimensional matrix structure corresponding to the pixel array section 521. The read-out region selecting section 527 sequentially selects one or a plurality of rows on the basis of a cycle set in advance, e.g. based on a rolling shutter. Further, the read-out region selecting section 527 may determine a selection region on the basis of requests from the pixels 530 in the pixel array section 521.

The optional signal generating section 528 may generate, on the basis of output signals of the pixels 530 selected by the read-out region selecting section 527, event signals corresponding to active pixels in which events have been detected of the selected pixels 530. The events mean an event that the intensity of light changes. The active pixels mean the pixel 530 in which the amount of change in light intensity corresponding to an output signal exceeds or falls below a threshold set in advance. For example, the signal generating section 528 compares output signals from the pixels 530 with a reference signal, and detects, as an active pixel, a pixel that outputs an output signal larger or smaller than the reference signal. The signal generating section 528 generates an event signal (event data) corresponding to the active pixel.

The signal generating section 528 can include, for example, a column selecting circuit configured to arbitrate signals input to the signal generating section 528. Further, the signal generating section 528 can output not only information regarding active pixels in which events have been detected, but also information regarding non-active pixels in which no event has been detected.

The signal generating section 528 outputs, through an output line 515, address information and timestamp information (for example, (X, Y, T)) regarding the active pixels in which the events have been detected. However, the data that is output from the signal generating section 528 may not only be the address information and the timestamp information, but also information in a frame format (for example, (0, 0, 1, 0, . . . )).

In the following description reference will mainly be made to sensor devices of the EVS type as described above in order to ease the description and to cover an important application example. However, the principles explained below apply just as well to different implementations of EVSs and in general to any imaging devices.

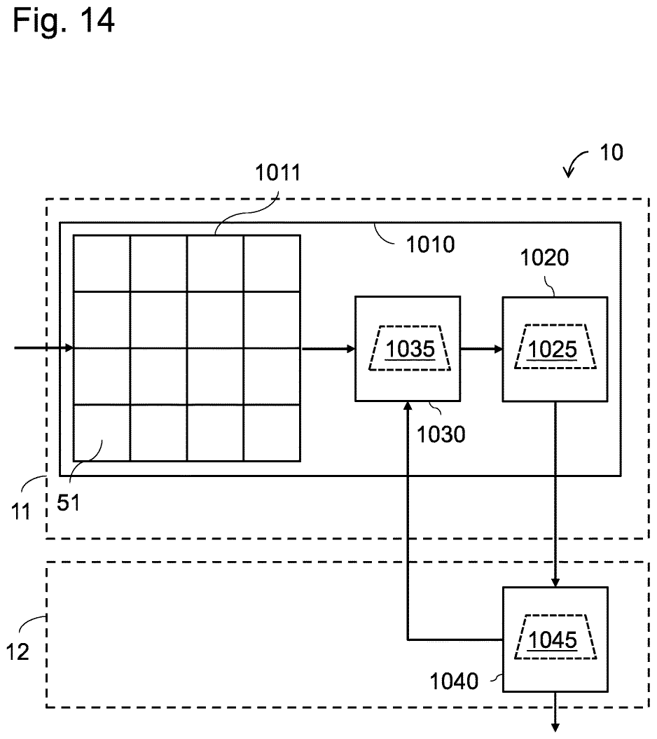

FIG. 14 shows a schematic illustration of a sensor device 10 that comprises a vision sensor 1010, an encoding unit 1020, and a control unit 1030.

The vision sensor 1010 includes a pixel array 1011 that comprises a plurality of event detection pixels 51 that are each configured to receive light from an observed scene and to perform photoelectric conversion to generate an electrical signal. The pixels 51 of the vision sensor 1010 may be standard imaging pixels that are configured to capture RGB or grayscale images of a scene on a frame basis. However, preferably, the pixels 51 are event detection pixels 51 that are each configured to asynchronously generate event data based on the received light, which event data indicate as an event the occurrence of an intensity change of the light above an event detection threshold. Thus, the vision sensor 1010 may constitute an EVS as described above with respect to FIGS. 1 to 13. The pixel array 1011 may be formed solely of event detection pixels 51 or may be a hybrid sensor array comprising a mixture of event detection pixels 51 and pixels that generate an electrical signal that indicates the absolute intensity of the received light. Also, the pixels 51 of the pixel array 1011 may have the ability to generate both, event data and intensity data, as was described above with respect to FIGS. 3 and 4.

The vision sensor 1010 may comprise further components besides the pixel array 1011. For example, the encoding unit 1020 and the control unit 1030 may be part of the vision sensor 1010 as illustrated in FIG. 14. Instead or additionally also other components may be part of the vision sensor 1010.

The event data are forwarded to the encoding unit 1020 of the sensor device 10. The encoding unit 1020 is configured to compress the event data provided from the pixel array 1011 according to different compression schemes. This means that the encoding unit 1020 is capable to compress/encode the event data in different manners such that the amount of data is reduced, while important features of the observed scene can still be reconstructed. In particular, high-level features can be extracted from the event data. As illustrated in FIG. 14, this may be implemented by using a first artificial intelligence algorithm 1025, preferably a neural network. However, compression may also be rule-based. Detailed examples of possible compression schemes will be given below.

The compressed event data are provided to a processing unit 1040 that is configured to carry out predetermined processing on the compressed event data. The processing unit 1040 may carry out any kind of predetermined operation, although of particular interest are operations in the field of image processing. For example, the processing unit 1040 may operate on the event data stream to generate/reconstruct a sharp image that is preferably free of imaging artifacts like noise or inter-pixel mismatch of the pixel array 1011 or handshake during image acquisition. Additionally or alternatively, the processing unit 1040 may also operate on the data stream without generating an image (or without generating an image that is appealing for a human observer). For example, the processing unit 1040 may execute classification tasks. It may classify the pixel signals/the data stream according to the observed scenes (e.g. country sides, city) or may classify objects (e.g. persons, cars, roadsides) or movements (e.g. hand gestures, approaching objects) within the observed scenes. Further, the processing unit 1040 may also segment observed scenes (e.g. healthy tissue—pathological tissue, road—curb). All these tasks or types of predetermined processing can be executed by a second artificial intelligence algorithm 1045, preferably by a neural network, that has been designed in an in principle known manner for the task at hand.

The control unit 1030 of the sensor device is configured to determine the compression scheme to be used by the encoding unit 1020 based on feedback information about the results of the predetermined processing that is provided from the processing unit 1040 to the control unit 1030. That is, the control unit 1030 evaluates the quality of the outcome of the predetermined operation that is notified from the processing unit 1040 to the control unit 1030. Here, the provided feedback information may merely contain the achieved result, such that the evaluation is carried out by the control unit 1030. However, the quality of the achieved result may also be checked at the side of the processing unit 1040 such that the feedback information contains a quality indicator that eases or predetermines the selection of an adapted encoding/compression scheme. Examples for feedback signals and/or quality metrics will be given below.

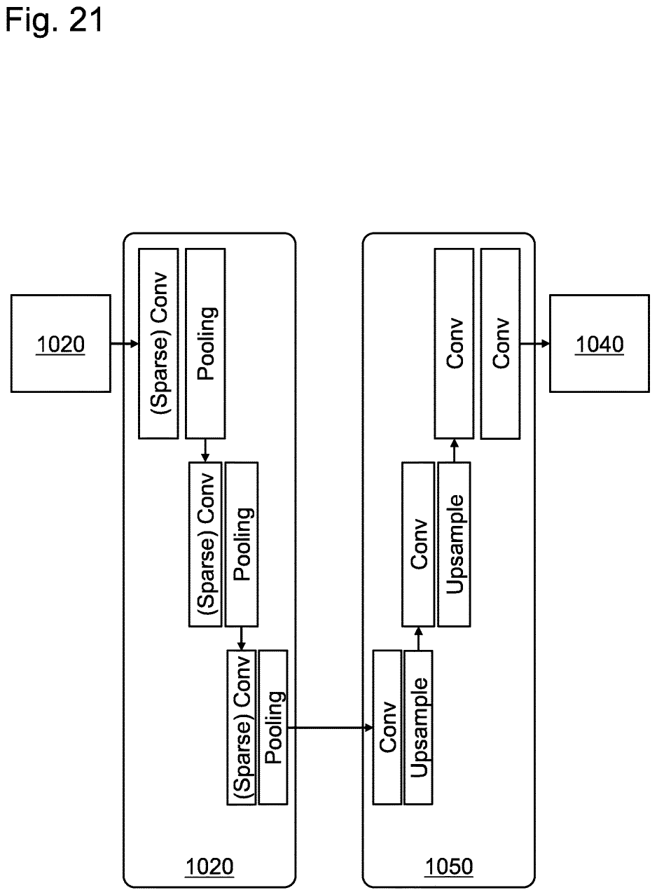

Based on the evaluation of the feedback information, the control unit 1030 determines how compression by the encoding unit shall proceed, i.e. whether parameters of a used compression scheme are to be changed or whether the used compression scheme has to be changed. Since the change of the compression will basically instantaneously change the result of the predetermined processing, and hence the feedback information, the control unit 1030 can find a compression scheme that prepares the event data optimally for the task to be fulfilled by the predetermined processing. This can either be done in a rule-based manner or by using a third artificial intelligence algorithm 1035, preferably a neural network, as illustrated in FIGS. 14 and 21. Here, the control unit 1030 may also be considered to be integrated into the encoding unit 1020, i.e. control unit 1030 and encoding unit 1020 form the same unit.

In this manner it is possible to adapt the data stream before the predetermined processing is applied to the data stream. This helps to provide the processing unit 1040 only with essential data that are necessary for the predetermined processing, while unimportant or redundant data are filtered out and discarded by the compression. This leads to a reduction of the amount of data to be transferred from the vision sensor 1010 to the processing unit 1040, which reduces the latency of the system. Further, the processing complexity, the processing time, and the energy consumed by the processing can be reduced, since less data are to be processed.

In the above description the processing unit 1040 may be constituted by a commonly known device and may for example be a computer, a processor, a CPU, a GPU, circuitry, software, a program or application running on a processor and the like. Moreover, the computational functions of the encoding unit 1020 and the control unit 1030 may also be carried out by any known device such a processor, a CPU, a GPU, circuitry, software, a program or application on a processor and the like. Thus, the nature of the computing devices executing the functions of the vision sensor 1010, the encoding unit 1020, the control unit 1030, and the processing unit 1040 are arbitrary, as long as they are configured to carry out the functions described herein.

As shown in FIG. 14, the pixel array 1011, the encoding unit 1020, and the control unit 1030 may be formed on a first chip, for example the sensor die 11 of FIG. 1. Further, the processing unit 1040 may be formed on a different, second chip, for example logic die 12 of FIG. 1. This is a typical architecture in which the event data are to be transferred between different chips/dies/substrates in order to process them. In such architectures the data transfer can constitute a bottleneck that will increase the latency of the predetermined processing. By compression the data amount to be transferred, and hence the data transmission time, can be reduced. By optimizing the compression scheme such that it fits optimally to the predetermined processing carried out by the processing unit 1040 this reduction of the transferred data amount does not affect the quality of the result of the predetermined processing.

However, all components shown in FIG. 14 may also be located on the same chip/die/substrate. Also in this case, the reduction of data to be transferred between the pixel array 1011 and the processing unit 1040 will help to reduce the latency, the processing complexity, and the processing time. Just the same, all components shown in FIG. 14, i.e. the pixel array 1011, the encoding unit 1020, the control unit 1030, and the processing unit 1040 may be located on different chips/dies/substrates. In particular, the encoding unit 1020 and the control unit 1030 may be provided on a dedicated chip that is separate from the chip of the pixel array 1011 and the chip of the processing unit 1040.

In addition (or alternatively) to controlling the selection of encoding schemes, the control unit 1030 may be configured to control which event data to forward to the encoding unit by spatially and/or temporally filtering the event data, preferably based on the feedback information. That is, filtering of event data is not only carried out by appropriate encoding/compression of the event data, but even before the encoding/compression event data are only forwarded selectively. This can be done with reference to the feedback information, i.e. in an adaptive manner that changes the manner to filter event data. But the selection may also adjustable based on criteria that differ from the quality of the predetermined processing. For example, a selection algorithm may be based on experience and block those event data for which it is known from experiment or previous studies that blocking said event data will not reduce the amount of information contained in the data.

Usually, corresponding filtering steps are performed on the processing unit side of the data transfer, i.e. on the second chip. Performing the filtering even before compression has a two-fold advantage. First, the data amount to be transferred is reduced, leading to a faster data transfer. Second, even the amount of data to be compressed is reduced, leading to a less complex processing for the compression. Both effects reduce the processing complexity and the latency of the system.

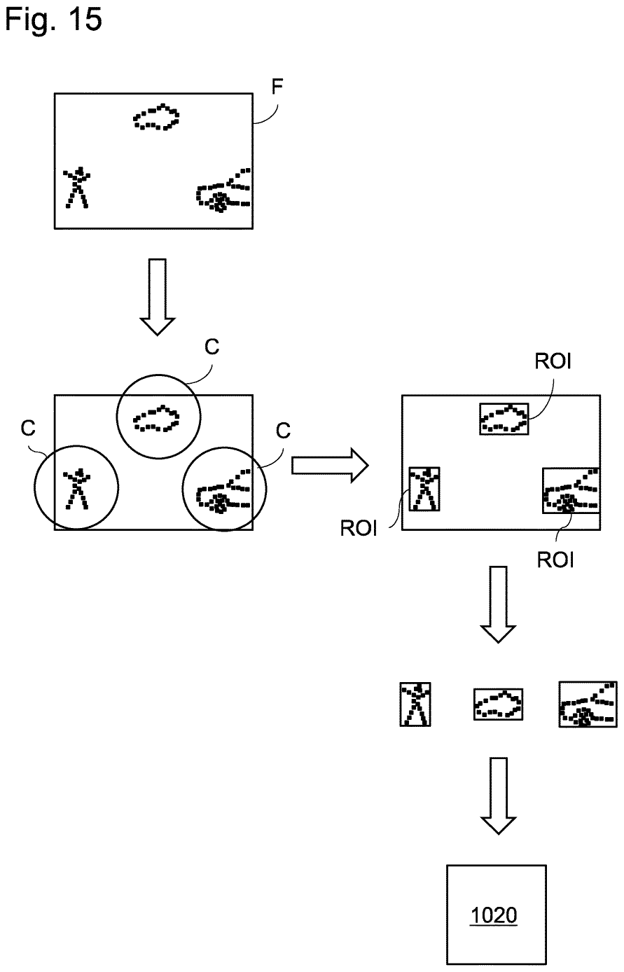

In this process, the control unit 1030 may determine regions of interest from the event data and restrict the event data that are forwarded to the encoding unit 1020 to event data within the regions of interest. This is schematically illustrated in FIG. 15.

FIG. 15 shows an exemplary set of events that occurred during a given time period and that are grouped into an event frame F that is generated e.g. as described with reference to FIG. 8 above. The events show motions of a human, a cloud, and a car. These events are clustered into clusters C in order to determine possible regions of interest, ROI. Here, the control unit 1030 may dynamically select between different clustering algorithms. For example, k-means clustering may be used, if the number of distinct objects is known, since this clustering algorithm sorts observations into k clusters corresponding to the distinct objects. Further, mean-shift clustering might be used with multiple mean-shift windows with overlap suppression, if the number of distinct objects is unknown. If the number of objects is known and there is substantial noise, density based spatial clustering of applications with noise, DBSCAN, might be used. All these algorithms are in principle known thus that a detailed description thereof can be omitted. Moreover, any other appropriate clustering algorithm might be used.

From the clusters C minimal areas, preferably rectangles as shown in FIG. 15, are determined that enclose the events of interest. In this manner a ROI is formed for every object. The events from each ROI can then be passed sequentially into the encoding unit 1020 with an indication of the ROIs pixel position and the size of the bounding box. This reduction of events to ROIs effectively omits all events that do not carry information about the ROIs. Thus, the transferred events can be reduced to the events of true interest. This of course further limits the data amount to be transferred.

In addition, selecting ROIs can be particularly useful if the predetermined processing is operating on a frame-based input. Each ROI can then be treated as a frame by the predetermined processing. This will focus the predetermined processing, e.g. object recognition or image reconstruction, separately to the respective ROIs, which will make the respective processing results more accurate, since interfering influences from other parts of the observed scene will not be present. Thus, splitting an event frame into “ROI-subframes” enhances the reliability and accuracy of the results of the predetermined processing.

It should be noted that the control unit 1030 may also turn the ROI detection off if it e.g. determines no improvement of the predetermined processing or that the entire frame consist only of ROIs. Also in this manner, the control unit 1030 can avoid wasting processing time.

Of course, instead of ROI selection also different spatial filtering algorithms may be applied. For example, only central portions of the observed scene may be forwarded, irrespective of their content. Also, event data may be binned, i.e. the spatial resolution of the event data may be reduced, if this does not negatively affect the outcome of the predetermined processing. In principle, any spatial filtering may be chosen, as long as it does reduce the data amount to be transferred without (unduly) deteriorating the result of the predetermined processing.

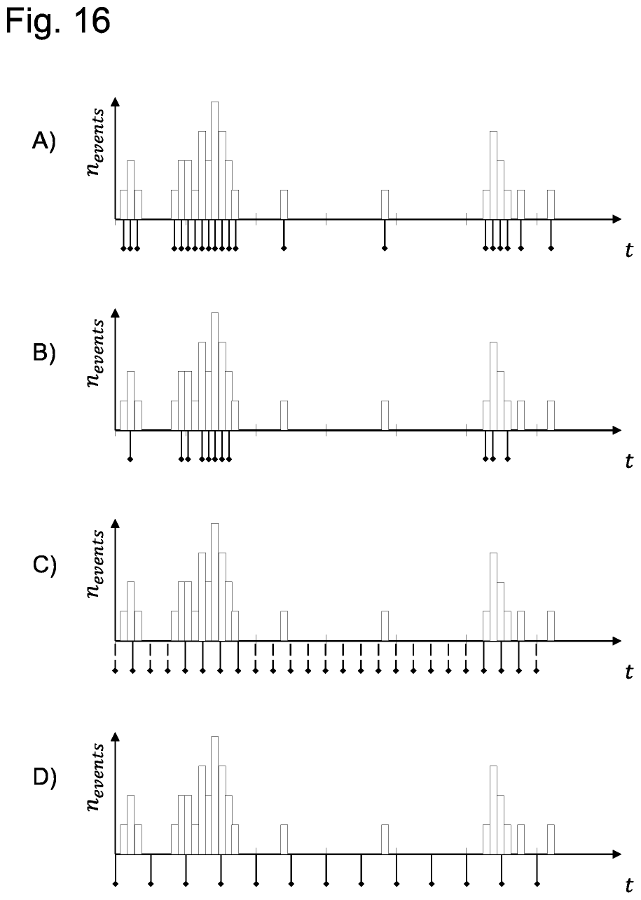

The control unit 1030 may instead or in addition determine points in time at which forwarding of event data is allowed and/or points in times at which forwarding of event data is forbidden. Examples for such temporal filtering modes are schematically illustrated in FIG. 16.

Here, diagram A) shows the situation without a temporal selection. All events that occur are directly forwarded. It might be necessary to choose this mode, if otherwise the result of the predetermined processing becomes insufficient.

Diagram B) shows a dynamic temporal selection. Only if a predetermined number of events did occur, the event data are forwarded to the encoding unit 1020. Otherwise, no data update is performed, which allows the encoding unit 1020 and the processing unit 1040 in principle to be idle. This, of course, reduces energy consumption.

Diagram C) refers to a temporal selection based on saturation. Here, a maximum update rate is specified (all lines). If less or no events are detected the update rate will be lower (dashed lines). If a saturation limit is hit, events will be discarded (solid lines) or randomly subsampled, i.e. a random selection among the too many events will be chosen for transfer. This apparently has the advantage that the processing unit 1040 will not have to face data bursts. Instead, input for the predetermined processing will be provided at max with the maximum update rate.

Diagram D) refers to a fixed readout rate. Events are accumulated in a fixed time window and passed to the encoding unit 1020 after the time window has ended.

Of course, many other temporal filters are possible. In particular, the filtering method may be chosen based on the feedback information or based on information regarding event clusters or ROIs and the according spatial filtering steps.

Temporal filtering mitigates the problem that the predetermined processing may not be fit for asynchronous event streams. For example, some neural networks (e.g. neuromorphic neural networks, (sparse) convolutional neural networks) will need a pulsed input. Usually, this problem is taken care of by pre-processing event data before inputting them into the processing unit 1040, e.g. by accumulating event data into dynamic or fixed time windows or any other frame-based representation of events. This adds computational complexity at the processing unit 1040 and uses extra bandwidth, especially in the case when no interesting features are actually present. Thus, by taking this preprocessing step to the side of the vision senor 1010, i.e. before data transmission, unnecessary communication can be further avoided.

In general, by filtering event data spatially and/or temporally the amount of data to be transferred to the processing unit 1040 can be reduced. This reduces the amount of data to be processed, and hence the processing complexity and the processing time.

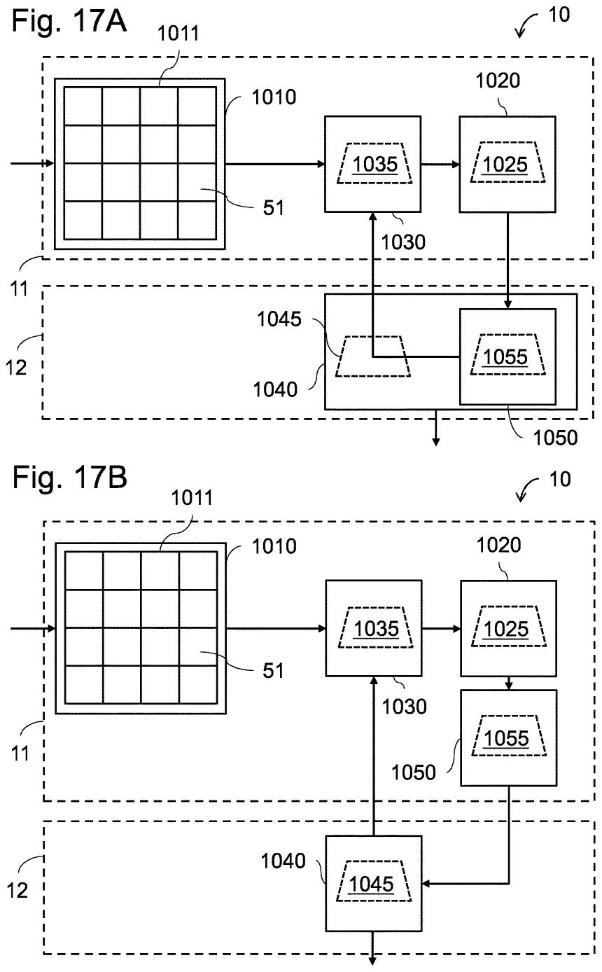

FIGS. 17A and 17B illustrate schematically an extension of the architecture described above. As shown in FIG. 17A the processing unit 1040 may comprise a decoding unit 1050 that is configured to transform the compressed event data into a predetermined form before the predetermined processing is carried out. Just the same, as shown in FIG. 17B, the decoding unit 1050 may be arranged at the die of the vision sensor 1010 or may be part of the vision sensor 1010, if also the encoding unit 1020 is part of the vision sensor 1010.

The decoding unit 1050 is configured to change the representation of the event data again in order to make them a fitting input for the processing unit 1040. Here, the decoding unit 1050 is not considered to fully restore the original event data, but merely to bring the reduced data into a form that can be easily handled by the processing unit 1040. The decoder is only required if the downstream task/algorithm expects a decompressed full representation of events, in some cases the algorithm might work directly with compressed event data, then no further decoding is required.

For example, if frames or feature embeddings are compressed, they usually need to be decompressed before they are provided to the processing unit 1040, if the processing unit can only operate on such frames or feature embeddings. Nevertheless, the restored frames/embeddings will contain less data than the original ones. Accordingly, the decoding unit 1050 helps to further optimize the data for the predetermined processing. It contributes therefore to the solution of the problem of how to increase data transmission efficiency while reducing the processing complexity. To this end, also the decoding unit 1050 may use a (fourth) artificial intelligence algorithm 1055, preferably a neural network.

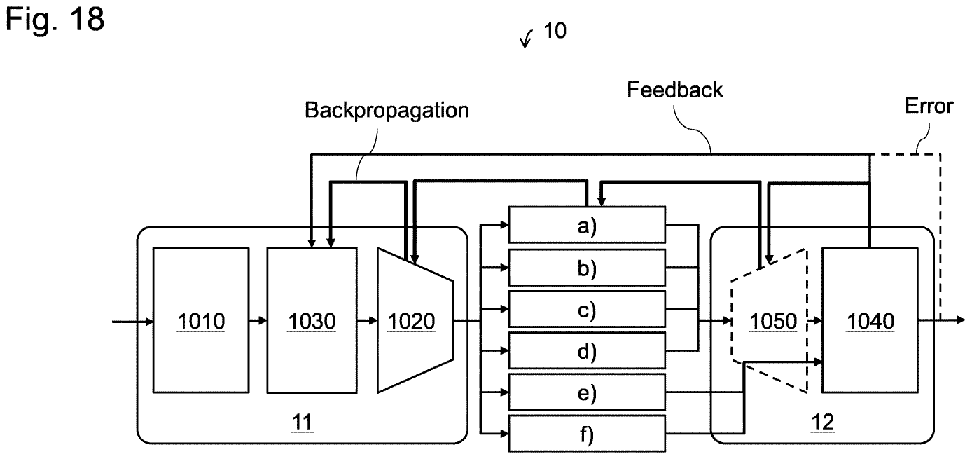

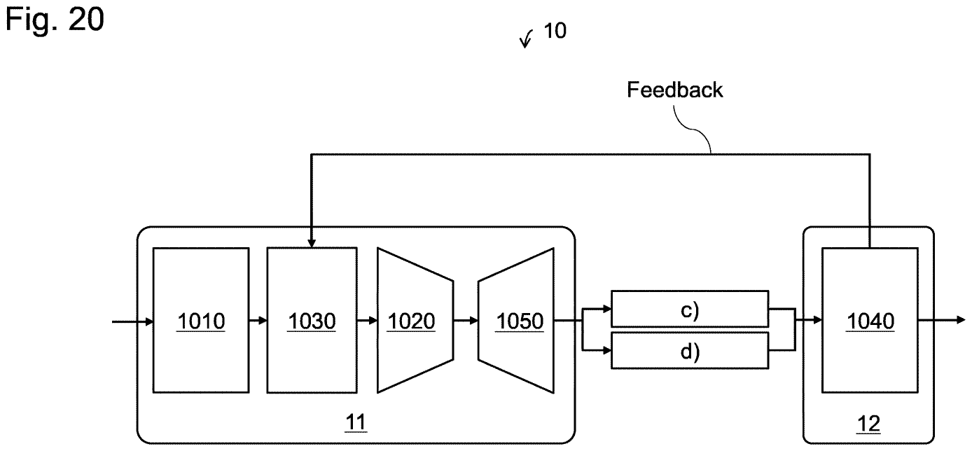

FIG. 18 is another schematic illustration of the sensor device 10 based on which more specific examples of the sensor device 10 will be described. As illustrated in FIG. 18 the vision sensor 1010, the encoding unit 1020, and the control unit 1030 are located on a first chip 11, while the processing unit 1040 and a corresponding (possibly unnecessary) decoding unit 1050 are located on a second chip 12. FIG. 20 shows an alternative example, where the decoding unit 1050 is also located on the first chip 11.

The encoding unit 1020 may be configured to compress the event data provided from the vision sensor 1010 according to any of the following encoding schemes:
a) Extracting feature embedding vectors
b) Compression of a stream of event frames or event vectors
c) Motion compensation of event frames
d) Extraction of motion vectors
e) Generation of event corners or event lines
f) Forwarding event data without compression

The control unit 1030 is configured to select anyone of said encoding schemes a) to f) based on the predetermined processing and/or the feedback information.

Compression scheme a) extracts feature embedding vectors from the event data, i.e. an ordered list of numerical properties of the observed scene. These feature embedding vectors are translated into a lower dimensional space by an embedding algorithm that preferably places similar features close to each other in the embedding space. The extraction of feature embedding vectors is a first step of data reduction since the feature embedding vectors will have less data than the full scene. The embedding reduces the data amount further. Since extraction of feature embedding vectors and embeddings of such vectors are in principle well-known further details can be omitted here.

Compression scheme b) applies standard image compression techniques to event frames or event vectors. Since these techniques are in principle well-known further details can be omitted here.

Compression scheme c) applies standard motion compensation techniques to event frames. Also these techniques are in principle well-known and need not to be described in detail here.

Compression scheme d) extracts motion vectors from event frames. Also this is parallel to motion vector extraction techniques known for intensity frame images. Therefore a detailed description can be omitted here.

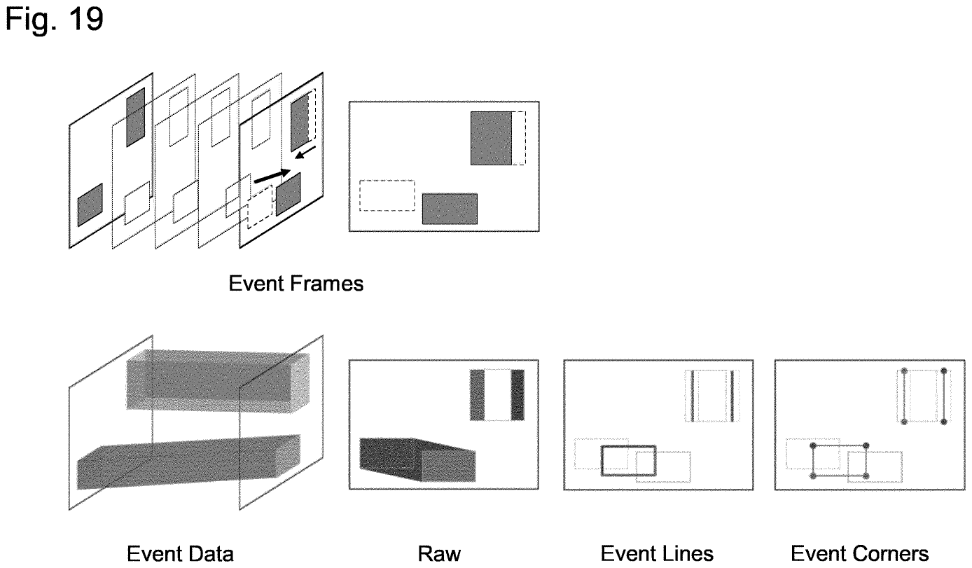

Compression scheme e) relates to the generation of event corners and/or event lines (see e.g. Mueggler et al.: “Fast Event-based Corner Detection” and Chamorro et al. “Event-Based Line SLAM in Real Time”, the content of which is incorporated by reference herein). What is to be understood by event corners and event lines is briefly explained with respect to FIG. 19.

In FIG. 19, a series of events over time is shown in the lower left corner. A representation of these event data in event frames is shown on the top of FIG. 19. Further, a spatially two-dimensional projection of the raw event data is shown. At the lower right, a reduction to event lines and to event corners is illustrated. As can be seen from the example of FIG. 19, event lines can be considered to be representative lines or borders of the raw event data. Event corners are then basically the intersections/ends of event lines. Apparently also compression scheme e) reduces the amount of event data.

Compression scheme f), i.e. no compression, might be useful in situations where the reduction in processing complexity cannot compensate the processing complexity required for the compression. The flexibility to switch off the compression contributes therefore to the reduction of the processing complexity, too.

Of course, the above list of possible compression schemes is not limiting, and also other compression schemes might be used by the encoding unit 1020.

As stated above, the control unit 1030 selects one of the available encoding schemes. This selection is on the one hand influenced by the predetermined processing carried out be processing unit 1040. In particular, if the processing unit 1040 is capable to change the predetermined processing dynamically, also a change of the encoding schemes will most probably be necessary. For example, to each task executable by the processing unit 1040, there might be one initial compression scheme stored in the control unit 1030, which initial compression scheme is carried out when the corresponding predetermined processing/task is started.

On the other hand, the selection can (additionally or alternatively) be based on the feedback information provided from the processing unit 1040 to the control unit 1030. As stated above, the feedback information may be merely an indicator of the result of the predetermined processing for a given setup of data filtering and data compression. But the feedback information may also be derived from a quality metric of the predetermined processing, i.e. it may be based on a measure that indicates which quality the achieved result has. In principle, various quality metrics are known. Which metric to use will depend on the predetermined processing.

For example, performance metrics of the predetermined processing can be used that indicate how well the predetermined processing performed. Also, metrics indicating computational complexity and/or speed of the predetermined processing may be used.

Examples for possible metrics are e.g. metrics that indicate the confidence that a classification of (parts of) an image to a label is correct (label confidence metric). Also, for image reconstruction/generation from event data the contrast histogram of the resulting image could be used as a measure for the quality.

A gradient intensity histogram, which indicates the distribution of sizes of gradients, can be used. contrast histogram and gradient intensity histogram metrics indicate whether an achieved sharpness of an image is sufficient, e.g. for a task related to the reduction of motion blur. Such examples could be used in an unsupervised adaption of the compression scheme that is e.g. executed by an artificial intelligence algorithm, since these metrics do not require a predetermined labelling of scene content/a ground-truth. Of course, also different unsupervised metrics could be used.

Examples for supervised metrics, i.e. metrics that operate with a known ground-truth, are e.g. metrics that are based on peak signal to noise ratio, PSNR, where noise is e.g. the compression error, or a structural similarity index measure, SSIM. Also perceptual image metrics, like e.g. perceptual evaluation of video quality, PEVQ, can be used. Also here, it is of course possible to use different metrics.

Since the above-named quality metrics are in principle well-known a detailed description can be omitted here.

Instead or in addition to using quality metrics the feedback information may be derived by annotating at least some of the results of the predetermined processing by a user of the sensor device 10. Preferably a binary signal is used that indicates whether the predetermined processing achieved the desired result according to the opinion of the user. Thus, a user may indicate that an error occurred, which triggers then a change of the underlying filtering/compression scheme. Such an interception or annotation by a user may also be carried out only from time-to-time, and not for all event data that is provided from the vision sensor 1010 to the processing unit 1040.

As stated above, various components of the sensor device 10 may employ artificial intelligence algorithms to achieve their respective goals. Here, it is advantageous that all artificial intelligence algorithms are trained together in order to optimize the predetermined processing. In particular, at least the first artificial intelligence algorithm 1025 of the encoding unit 1020 that carries out the compression and the second artificial intelligence algorithm 1045 of the processing unit 1040 that carries out the predetermined processing should be trained together.

In particular, a joint learning objective or loss function can be defined for the artificial intelligence algorithms:

$$L = {λ}_{1} {L}_{1} + … + {λ}_{n} {L}_{n}$$

by adding loss functions Lₖ for all k involved artificial intelligence algorithms with tunable weight parameters λₖ.

If the artificial intelligence algorithms are constituted by differentiable neural networks, then the parameters of these networks can be optimized by using backpropagation, preferably with gradient descent or more preferably with stochastic gradient descent as e.g. described in “Deep Learning, volume 1” by Goodfellow et al. (MIT Press, 2016), the content of which his hereby incorporated by reference.

Training labels, i.e. desired estimations of the predetermined processing, may be only provided for the combined task, i.e. for the output of the predetermined processing, while labels for the loss function of the intermediate networks might be deducible therefrom. In principle, by back propagating the entire/combined loss L over the combined neural network it will be possible to optimize the network even without using exact expression for the individual loss functions Lₖ.

Of course, task objectives for the individual neural networks may also be decoupled, i.e. labels for each training task may be set individually.

In this manner, a powerful combined neural network can be set up, for example in a pre-training step, where the behavior of the system is simulated for a large training data set in order to adjust the parameters of the neural network. After training is finished, the parameters are fixed. In this scenario executing the neural networks will not need much processing power, since the processing will basically consist of activating the networks according to their fixed parameters.

However, the training may also use a continual learning algorithm that is based on the feedback information. This ensures that the model can be adapted to changing situations, which makes the system at the same time more flexible and more robust. Here, it might also be possible that only a part of the artificial intelligence algorithms that are present are subject to continual learning, after all artificial intelligence algorithms have been pre-trained together.

In a continual learning setup the same formula for the total loss function can be used. In this case backpropagation as used in the pre-training setup may be combined with experience repay as e.g. explained in “Learning and Categorization in Modular Neural Networks” by Murre or other methods that avoid catastrophic forgetting and writing of neural network parameters as e.g. described in “Catastrophic Forgetting in Connectionist Networks” by French, which documents are both incorporated by reference herein. Of course, any other well-known continual learning algorithm may be used.

In the following a brief overview of exemplary implementations of the sensor device is given. This overview is not intended to be limiting. In particular, described components and/or algorithms may be exchangeable between different examples, if this makes technically sense.

According to a first example, the encoding unit 1020 may be changeable between compression schemes e) and f) of FIG. 17, i.e. between the generation of event lines/event corners and the transmission of the raw event data. These are provided to the processing unit 1040 e.g. for pose estimation or for simultaneous localization and mapping, SLAM. In this setup, no decoding unit 1050 needs to be present, since the event features, i.e. corners and lines, can be directly used as input for the tasks/the predetermined processing at hand. The feedback information will contain a task performance metric, a computational complexity/speed metric, and/or a binary signal indicating successful solving of the task at hand. The control unit 1030 can then switch between event feature extraction and forwarding of raw events. Moreover, the control unit 1030 may optimize the time window that is used to accumulate the events based on which the line and/or corner extraction is performed. In this example, the encoding unit 1020 and the processing unit 1040 may operate rule-based or by using artificial intelligence algorithms.

According to a second example, the encoding unit 1020 may be changeable between compression schemes a) and b) of FIG. 17, i.e. between the extraction and embedding of feature embedding vectors having a fixed size and the compression of a stream of event frames or event vectors having fixed dimensions. The input for the encoding unit 1020 is preferably an event frame representation, like event frames or voxel grids. In this setup, a decoding unit 1050 is provided that operates on the compressed data after they have been transferred to the second chip 12. The encoding unit 1020 as well as the decoding unit 1050 may be constituted by convolutional neural networks as illustrated in FIG. 21, which form a U-net. Here, the encoding unit 1020 comprises three double layers, where each double layer consists of a convolutional layer and a pooling layer. The decoding unit 1050 comprises also three double layers. The first two consist of a convolutional layer and an upsampling layer, while the third double layer consists of two convolutional layers. Here, the encoding unit 1020 and the decoding unit 1050 may be pre-trained or trained continuously. Also, only one of these units may be trained continuously, e.g. the decoding unit 1050. The feedback information will contain a task performance metric, a computational complexity/speed metric, and/or a binary signal indicating successful solving of the task at hand. The control unit 1030 can then switch between compression schemes a) and b). Moreover, the control unit 1030 may optimize the time window that is used to accumulate the events into event frames based on which the compression or the extraction of feature embedding vectors is performed.

According to a variant of the above example, also raw event data may be used as input for the encoding unit 1020. In this setup the convolutional layers of the encoding unit 1020 need to be replaced with sparse submanifold convolutional layers, as indicated by “(Sparse)” in FIG. 21. Otherwise the functionality of the second example will not be changed.

In a further variant of the second example, the encoding unit 1020 is continuously trained, while the decoding unit 1050 may either be pre-trained or also continuously trained. Here, the continual training may also be switched off by the control unit 1030. For example, if a sufficient level of quality is reached, training can be suspended for a given time period in order to save processing resources. After the given time period the continual training can be started again. As indicated above, in this setup backpropagating (preferably using stochastic gradient descent) of loss from unit to unit can be used as additional feedback, as schematically indicated in FIG. 18, if all processing steps/artificial intelligence algorithms are differentiable. The encoding unit 1020 and the decoding unit 1050 form again a U-net as the one illustrated in FIG. 21. Here, the control unit 1030 may adapt the number of events per frame or the output rate of event data. Basically any quality metric might be used such as PSNR, SSIM, mean squared error metrics, or contrast histogram metrics. Further, binary signals indicating success or failure may be supplemented as feedback signal.

In yet another variant, the decoder could also be turned off if the downstream algorithm to process the specified task is designed to directly act on the feature embedding, which is the output of the encoder (e.g. left part of the U-Net). This would further reduce computational complexity. The on-sensor neural network-based compression (encoder) can also be trained end-to-end with the neural network of the downstream processing task if all operations are differentiable.

As mentioned above, and as shown in FIG. 20, the decoding unit 1050 may also be part of the first chip 11, i.e. decoding/decompression is carried out before the data are transmitted to the processing unit 1040. In this case, the resulting data may be the result of compression schemes c) or d) of FIG. 18, i.e. of motion compensation of event frames or of extraction of motion vectors. The encoding unit 1020 and the decoding unit 1050 may be constituted by convolutional neural networks as described above with respect to FIG. 21. The system will operate as described with respect to the second example above.

All these examples have in common that the control unit 1030 may control the filtering of data that reach the encoding unit 1020 and the compression done by the encoding unit 1020 based on feedback information from the processing unit 1040 about the success of performing a predetermined processing based on the compressed data. This reduces the amount of data to be transferred and to be processed, while the quality of the predetermined processing is ensured. In this manner, processing complexity, latency, and energy consumption can be reduced.

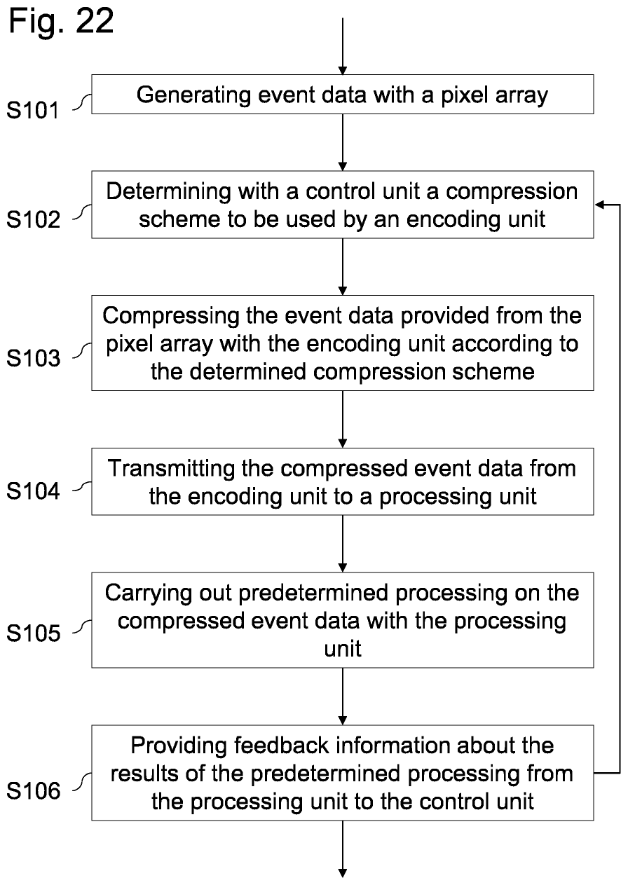

The above function can be summarized by a method for operating a sensor device 10, whose process flow is schematically illustrated in FIG. 22.

At S101 event data are generated with the pixel array 1011 of the vision sensor (1010).

At S102, with the control unit 1030 of the sensor device 10, a compression scheme out of the plurality of different compression schemes is determined, which compression scheme is to be used by the encoding unit 1020 of the sensor device 10.

At S103 the event data provided from the pixel array 1011 are compressed with the encoding unit 1020 by using the determined compression scheme.

At S104 the compressed event data are transmitted from the encoding unit 1020 to the processing unit 1040.

At S105 predetermined processing is carried out on the compressed event data with the processing unit 1040.

At S106 feedback information about the results of the predetermined processing from the processing unit 1040 is provided to the control unit 1030, which then determines at S102 which compression scheme to be used based on the feedback information.

In this manner an optimal compression can be found based on the feedback from the processing unit 1040. This will reduce the processing complexity, the latency, and the energy consumption of the sensor device 10.

The technology according to the above (i.e. the present technology) is applicable to various products. For example, the technology according to the present disclosure may be realized as a device that is installed on any kind of moving bodies, for example, vehicles, electric vehicles, hybrid electric vehicles, motorcycles, bicycles, personal mobilities, airplanes, drones, ships, and robots.

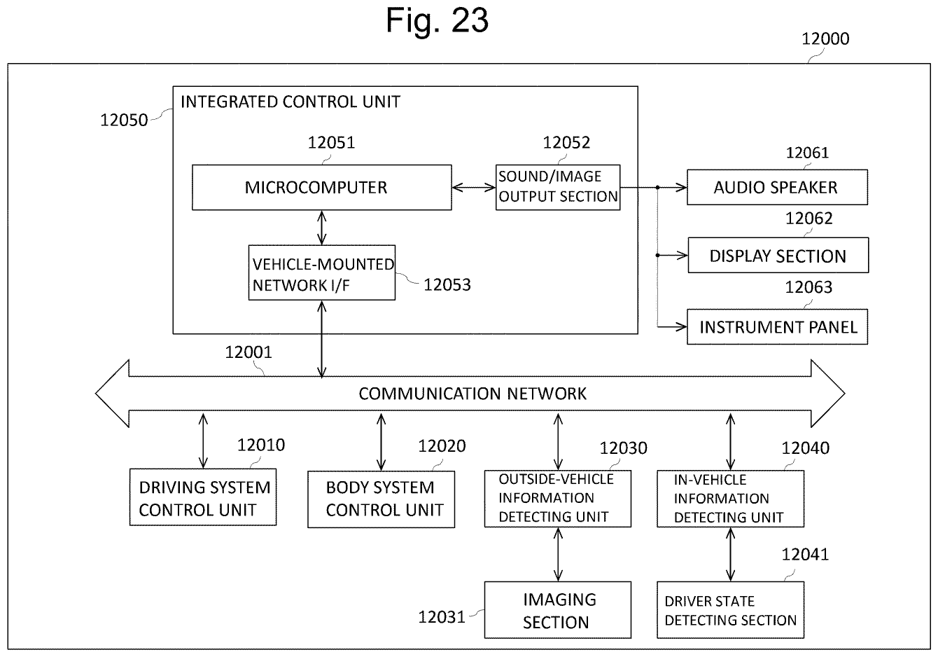

FIG. 23 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 23, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 23, an audio speaker 12061, a display section 12062, and an instrument panel 12063 are illustrated as the output device. The display section 12062 may, for example, include at least one of an on-board display and a head-up display.

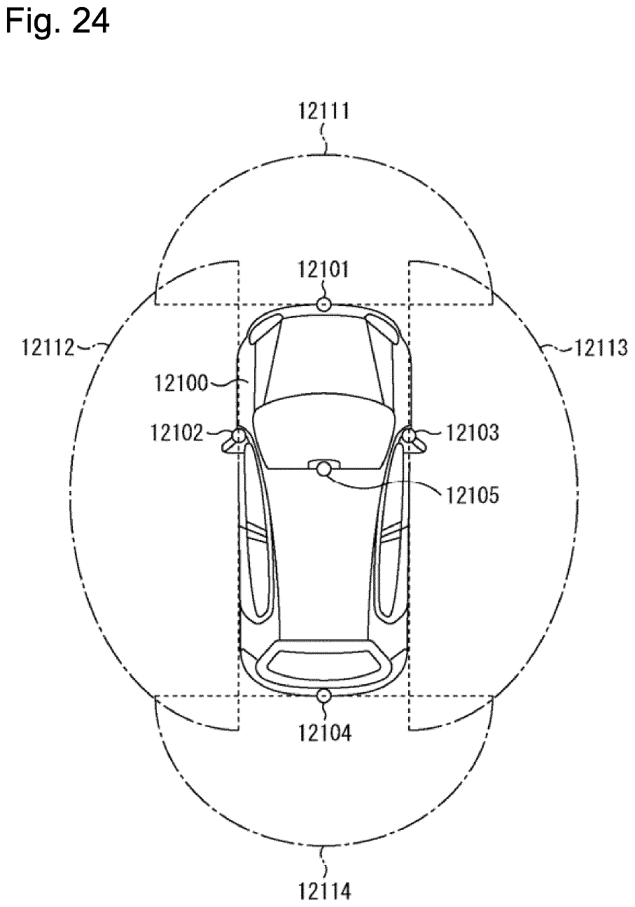

FIG. 24 is a diagram depicting an example of the installation position of the imaging section 12031.

In FIG. 24, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 24 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-mentioned configurations. Specifically, the sensor device 10 is applicable to the imaging section 12031. The imaging section 12031 to which the technology according to the present disclosure has been applied flexibly acquires event data and performs data processing on the event data, thereby being capable of providing appropriate driving assistance.

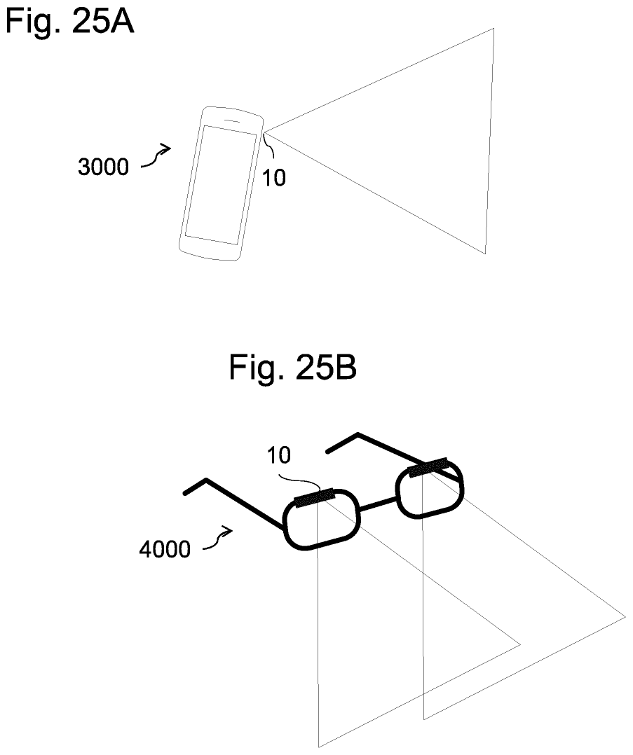

Further possible implementations of the sensor device 10 are mobile devices 3000 such as cell phones, tablets, smart watches and the like as shown in FIG. 25A or head-mounted displays 4000 as shown in FIG. 25B. Further, the sensor device 10 is useable in augmented and/or virtual reality applications/cameras or in surveillance systems like 360° cameras.

Note that, the embodiments of the present technology are not limited to the above-mentioned embodiment, and various modifications can be made without departing from the gist of the present technology.

Further, the effects described herein are only exemplary and not limited, and other effects may be provided.

Note that, the present technology can also take the following configurations.

[1] A sensor device (10) comprising:
a vision sensor (1010) that comprises a pixel array (1011) having a plurality of event detection pixels (51) each being configured to receive light and to perform photoelectric conversion to generate event data based on the received light, which event data indicate as an event the occurrence of an intensity change of the light above an event detection threshold;
an encoding unit (1020) that is configured to compress the event data provided from the pixel array (1011) according to different compression schemes;
a control unit (1030) that is configured to determine the compression scheme to be used by the encoding unit (1020); and
a processing unit (1040) that is configured to receive the compressed event data from the encoding unit (1020) and to carry out predetermined processing on the compressed event data; wherein
the processing unit (1040) provides feedback information about the results of the predetermined processing to the control unit (1030); and
the control unit (1030) is configured to use the feedback information to determine the compression scheme to be used.
   [2] The sensor device (10) according to [1], comprising
a first chip (11) on which the pixel array (1011), the encoding unit (1020), and the control unit (1030) are formed; and
a second chip (12) on which the processing unit (1040) is formed.
   [3] The sensor device (10) according to [1] or [2], wherein
the vision sensor (1010) comprises the encoding unit (1020) and the control unit (1030).
   [4] The sensor device (10) according to any one of [1] to [3], wherein
the control unit (1030) is configured to control which event data to forward to the encoding unit by spatially and/or temporally filtering the event data, preferably based on the feedback information.
   [5] The sensor device (10) according to [4], wherein
the control unit (1030) is configured to determine regions of interest from the event data and to restrict the event data that are forwarded to the encoding unit (1020) to event data within the regions of interest; and/or
the control unit (1030) is configured to determine points in time at which forwarding of event data is allowed and/or forbidden.
   [6] The sensor device (10) according to any one of [1] to [5], wherein
the processing unit (1040) comprises a decoding unit (1050) that is configured to transform the compressed event data into a predetermined form before the predetermined processing is carried out.
   [7] The sensor device (10) according to any one of [1] to [5], wherein
the vision sensor (1010) comprises a decoding unit (1050) that is configured to transform the compressed event data into a predetermined form before it is transmitted to the processing unit (1040).
   [8] The sensor device (10) according to any one of [1] to [7], wherein
the encoding unit (1020) is configured to compress the event data by any of the encoding schemes of extracting and embedding feature embedding vectors, compression of a stream of event frames or event vectors, motion compensation of event frames, extraction of motion vectors, generation of event corners, generation of event lines, forwarding event data without compression; and
the control unit (1030) is configured to select anyone of said encoding schemes based on the predetermined processing and/or the feedback information.
   [9] The sensor device (10) according to any one of [1] to [8], wherein
the encoding unit (1020) applies an artificial intelligence algorithm (1025) to carry out the compression.
   [10] The sensor device (10) according to any one of [1] to [9], wherein
the processing unit (1040) applies an artificial intelligence algorithm (1045) to carry out the predetermined processing.
   [11] The sensor device according (10) to any one of [1] to [8], wherein
the encoding unit (1020) applies a first artificial intelligence algorithm (1025) to carry out the compression and the processing unit (1040) applies a second artificial intelligence algorithm (1045) to carry out the predetermined processing; and
at least the first artificial intelligence algorithm (1025) and the second artificial intelligence algorithm (1045) are trained together in order to optimize the predetermined processing.
   [12] The sensor device (10) according to [11], wherein
the first artificial intelligence algorithm (1025) and the second artificial intelligence algorithm (1045) are differentiable neural networks; and
training uses backpropagation using, preferably stochastic, gradient descent.
   [13] The sensor device (10) according to [11], wherein
training uses a continual learning algorithm that is based on the feedback information.
   [14] The sensor device (10) according to any one of [1] to [13], wherein
the feedback information is derived from a quality metric of the predetermined processing, preferably a performance metric of the predetermined processing or a metric indicating computational complexity and/or speed of the predetermined processing, and/or
the feedback information is derived by annotating at least some of the results of the predetermined processing by a user of the sensor device (10), preferably by a binary signal that indicates whether the predetermined processing achieved the desired result.
   [15] A method for operating a sensor device (10), the method comprising:
generating event data with a pixel array (1011) of a vision sensor (1010), the pixel array (1011) having a plurality of event detection pixels (51) each being configured to receive light and to perform photoelectric conversion to generate the event data based on the received light, which event data indicate as an event the occurrence of an intensity change of the light above an event detection threshold;
determining, with a control unit (1030) of the sensor device (10), a compression scheme out of a plurality of different compression schemes, which compression scheme is to be used by an encoding unit (1020) of the sensor device (10);
compressing the event data provided from the pixel array (1011) with the encoding unit (1020) by using the determined compression scheme;
transmitting the compressed event data from the encoding unit (1020) to a processing unit (1040);
carrying out predetermined processing on the compressed event data with the processing unit (1040); and
providing feedback information about the results of the predetermined processing from the processing unit (1040) to the control unit (1030); wherein
the control unit (1030) is configured to use the feedback information to determine the compression scheme to be used.

1. A sensor device comprising:
a vision sensor that comprises a pixel array having a plurality of event detection pixels each being configured to receive light and to perform photoelectric conversion to generate event data based on the received light, which event data indicate as an event the occurrence of an intensity change of the light above an event detection threshold;
an encoding unit that is configured to compress the event data provided from the pixel array according to different compression schemes;
a control unit that is configured to determine the compression scheme to be used by the encoding unit; and
a processing unit that is configured to receive the compressed event data from the encoding unit and to carry out predetermined processing on the compressed event data; wherein
the processing unit provides feedback information about the results of the predetermined processing to the control unit; and
the control unit is configured to use the feedback information to determine the compression scheme to be used.

2. The sensor device according to claim 1, comprising
a first chip on which the pixel array, the encoding unit, and the control unit are formed; and
a second chip on which the processing unit is formed.

3. The sensor device according to claim 1, wherein
the vision sensor comprises the encoding unit and the control unit.

4. The sensor device according to claim 1, wherein
the control unit is configured to control which event data to forward to the encoding unit by spatially and/or temporally filtering the event data, preferably based on the feedback information.

5. The sensor device according to claim 4, wherein
the control unit is configured to determine regions of interest from the event data and to restrict the event data that are forwarded to the encoding unit to event data within the regions of interest; and/or
the control unit is configured to determine points in time at which forwarding of event data is allowed and/or forbidden.

6. The sensor device according to claim 1, wherein
the processing unit comprises a decoding unit that is configured to transform the compressed event data into a predetermined form before the predetermined processing is carried out.

7. The sensor device according to claim 1, wherein
the vision sensor comprises a decoding unit that is configured to transform the compressed event data into a predetermined form before it is transmitted to the processing unit.

8. The sensor device according to claim 1, wherein
the encoding unit is configured to compress the event data by any of the encoding schemes of extracting and embedding feature embedding vectors, compression of a stream of event frames or event vectors, motion compensation of event frames, extraction of motion vectors, generation of event corners, generation of event lines, forwarding event data without compression; and
the control unit is configured to select any one of said encoding schemes based on the predetermined processing and/or the feedback information.

9. The sensor device according to claim 1, wherein
the encoding unit applies an artificial intelligence algorithm to carry out the compression.

10. The sensor device according to claim 1, wherein
the processing unit applies an artificial intelligence algorithm to carry out the predetermined processing.

11. The sensor device according to claim 1, wherein
the encoding unit applies a first artificial intelligence algorithm to carry out the compression and the processing unit applies a second artificial intelligence algorithm to carry out the predetermined processing; and
at least the first artificial intelligence algorithm and the second artificial intelligence algorithm are trained together in order to optimize the predetermined processing.

12. The sensor device according to claim 11, wherein
the first artificial intelligence algorithm and the second artificial intelligence algorithm are differentiable neural networks; and
training uses backpropagation using, preferably stochastic, gradient descent.

13. The sensor device according to claim 11, wherein
training uses a continual learning algorithm that is based on the feedback information.

14. The sensor device according to claim 1, wherein
the feedback information is derived from a quality metric of the predetermined processing, preferably a performance metric of the predetermined processing or a metric indicating computational complexity and/or speed of the predetermined processing, and/or
the feedback information is derived by annotating at least some of the results of the predetermined processing by a user of the sensor device, preferably by a binary signal that indicates whether the predetermined processing achieved the desired result.

15. A method for operating a sensor device, the method comprising:
generating event data with a pixel array of a vision sensor, the pixel array having a plurality of event detection pixels each being configured to receive light and to perform photoelectric conversion to generate the event data based on the received light, which event data indicate as an event the occurrence of an intensity change of the light above an event detection threshold;
determining, with a control unit of the sensor device, a compression scheme out of a plurality of different compression schemes, which compression scheme is to be used by an encoding unit of the sensor device;
compressing the event data provided from the pixel array with the encoding unit by using the determined compression scheme;
transmitting the compressed event data from the encoding unit to a processing unit;
carrying out predetermined processing on the compressed event data with the processing unit; and
providing feedback information about the results of the predetermined processing from the processing unit to the control unit; wherein
the control unit is configured to use the feedback information to determine the compression scheme to be used.
